(19) United States
(12) Patent Application Publication
(10) Pub. No.: US 2026/0330615 A1
(43) Pub. Date: Oct. 22, 2026

(54) OPTIMIZATION OF VISIBLE PIXELS FOR SURROUND VIEW AND OTHER ENVIRONMENT VISUALIZATIONS

(71) Applicant: NVIDIA CORPORATION, Santa Clara, CA (US)

(72) Inventors: Yuzhuo Ren, Sunnyvale, CA (US); Robin Brian Jenkin, Morgan Hill, CA (US); Yining Deng, Fremont, CA (US); Niranjan Avadhanam, Saratoga, CA (US); Srikar Reddy Narapureddy, San Jose, CA (US); Choong Gyo Jung, Santa Clara, CA (US)

(21) Appl. No.: 19/180,963

(22) Filed: Apr. 16, 2025

(51) Int. Cl. G06T 5/77; G06T 3/4053; G06T 5/70

(52) U.S. Cl. CPC G06T 5/77; G06T 3/4053; G06T 5/70; G06T 2207/10024

(57) ABSTRACT

In various examples, an ego-machine may be equipped with any number and type of sensor(s), the sensor(s) may be used to generate frames of overlapping images, and a reverse projection may be used to sample the image data from corresponding sensor(s) and generate a reverse projection view through a designated or applicable viewport. Regional magnification factors or pixel densities may be measured or computed, and different sampling strategies may be used to sample the image data for different regions of the reverse projection view based on the regional magnification factors or pixel densities to control local sampling strategies in local regions of the reverse projection view. Image quality processing may be performed on the pixels that are visible in the reverse projection view (e.g., instead of on the original image data). The resulting visualization may be presented on a display visible to an occupant or operator of the ego-machine.

### BACKGROUND

Vehicle environment visualization systems provide vehicle occupants with a visualization of the area surrounding an ego-vehicle. For drivers, environment visualization systems provide the driver with the ability to view the surrounding area -- including blind spots where the driver’s line of sight is occluded by parts of the vehicle or other objects in the environment -- without the need to reposition (e.g., turn their head, get off the driver’s seat, lean a certain direction, etc.). This visualization may assist and facilitate a variety of driving maneuvers, such as smoothly entering or exiting a parking spot without hitting objects such as a road curb, pedestrians, or other vehicles. More and more vehicles, especially luxury brands or new models, are being produced with environment visualization systems equipped.

Existing vehicle environment visualization systems usually utilize fisheye cameras – typically mounted at the front, left, rear, and right sides of the vehicle body – to perceive the surrounding area from multiple directions. Additional cameras may be included in special cases, like for long trucks or vehicles with trailers. Frames of image data from the individual cameras may be stitched together using camera parameters to align frames and blending techniques to combine overlapping regions to provide a horizontal 360° surround view visualization, and the visualization may be displayed on a monitor that is visible to an operator or occupant. In some implementations, an operator or occupant may interact with the visualization through a user interface, navigating a virtual camera to different viewports, zooming in, or zooming out to focus on specific regions of interest.

However, existing environment visualization systems and other techniques for generating visualizations of a surrounding environment have some drawbacks. For example, raw image data generated using surround view cameras often contains sensor noise and exhibits limited dynamic range. An Image Signal Processor (ISP) may be used to perform tasks like noise reduction, auto exposure, white balance, and initial color correction, followed by post-ISP image quality algorithms, such as temporal noise reduction (TNR), color correction, global tone mapping, and color harmonization across images from different cameras. However, existing image processing techniques often use computational resources inefficiently and lead to a range of visual artifacts that degrade image quality and user experience. For example, TNR may not remove all noise and may introduce ghosting effects or texture distortions such as blurring or the disappearance of moving objects. Color correction may result in inconsistent color reproduction across stitched images, causing unnatural hues or mismatched tones in regions of interest. Global tone mapping may lead to incorrect exposure adjustments in regions of interest, producing overly dark or overly bright regions that represent color differently than the way our eyes perceive it. Harmonization may introduce geometric distortions such as size or shape misalignments between different camera views in regions of interest. These artifacts reduce the accuracy and realism of the environment visualization system, are often distracting to the driver, and can interfere with situational awareness and the safe operation of the vehicle in certain scenarios.

As a result, there is a need for improved visualization techniques that reduce visual artifacts, better represent useful visual information, and/or otherwise improve the visual quality of resulting images.

### SUMMARY

Embodiments of the present disclosure relate to optimization of visible pixels for surround view and other environment visualizations. In contrast to conventional systems, systems and methods are disclosed that that use a reverse projection to render a visualization through a selected or applicable two-dimensional (2D) viewport and apply image quality processing to the pixels that will be visible in the viewport.

For example, an ego-machine may be equipped with any number and type of sensor(s) (e.g., one or more cameras, such as fisheye cameras), and the sensor(s) may be used to generate frames of overlapping sensor data (e.g., overlapping image data) representing substantially the same time slice. A reverse projection may be used to sample the image data from corresponding sensor(s) and generate a reverse projection view through a designated or applicable viewport. Regional magnification factors or pixel densities (e.g., quantifying the density of input pixel values or color measurements to the density of output pixels) may be measured by comparing corresponding areas of dot images or image patches before and after projecting through the viewport. In some embodiments, different sampling strategies (e.g., upsampling, downsampling, super resolution, anti-aliasing, regional subsampling, warping subsampled pixels, etc.) may be used to sample the image data for different regions of the reverse projection view based on the regional magnification factors or pixel densities to control local sampling strategies in local regions of the reverse projection view. Additionally or alternatively, image quality processing (e.g., temporal noise reduction, color adjustment, tone mapping) may be performed on the pixels that are visible in the reverse projection view (e.g., instead of performing that image processing on the original image data). The resulting visualization may be presented on a display visible to an occupant or operator of the ego-machine (e.g., a driver or passenger, a remote operator). The techniques described herein may be used to improve visual quality of surround view visualization and other environment visualizations, reduce latency in generating these visualizations, and therefore promote safe operation of the vehicle.

### BRIEF DESCRIPTION OF THE DRAWINGS

The present systems and methods for optimization of visible pixels for surround view and other environment visualizations are described in detail below with reference to the attached drawing figures, wherein:

FIG. 1 is a diagram illustrating an example data flow through an example Surround View System, in accordance with some embodiments of the present disclosure;

FIG. 2 is an illustration of an example dot pattern image, in accordance with some embodiments of the present disclosure;

FIG. 3 illustrates how the dot pattern image of FIG. 2 may project onto an example projection surface, in accordance with some embodiments of the present disclosure;

FIGS. 4 and 5 illustrate how applying temporal noise reduction in the viewport may be used to impact image quality, in accordance with some embodiments of the present disclosure;

FIG. 6 is a flow diagram showing a method for performing one or more image quality operations in a reverse projection view, in accordance with some embodiments of the present disclosure;

FIG. 7A is an example of sensor locations having corresponding fields of view or sensory fields for example autonomous or semi-autonomous machines, in accordance with at least some embodiments of the present disclosure;

FIG. 7B is an illustration of an example of component and sensor locations on an autonomous or semi-autonomous vehicle, in accordance with at least some embodiments of the present disclosure;

FIG. 7C is a block diagram of an example system architecture for an autonomous or semi-autonomous vehicle, robot, and/or other machine type, in accordance with at least some embodiments of the present disclosure;

FIG. 7D is a block diagram of an example architecture of a computing system – such as a system-on-a-chip (SoC) – in accordance with at least some embodiments of the present disclosure;

FIG. 7E is a system diagram for communication between cloud-based server(s) and an example autonomous or semi-autonomous vehicle, robot, and/or other machine type, in accordance with at least some embodiments of the present disclosure;

FIG. 8 is a system diagram illustrating a three computer ecosystem, including a computing system for generating or creating artificial intelligence (AI) – such as AI training and validation data, a computing system for training artificial intelligence, and a computing system deploying the AI at the edge, in accordance with at least some embodiments of the present disclosure;

FIG. 9 is a block diagram of an example computing system for generative artificial intelligence (AI), in accordance with at least some embodiments of the present disclosure; and

FIG. 10 is a block diagram of an example computing device, in accordance with at least some embodiments of the present disclosure.

### DETAILED DESCRIPTION

Systems and methods are disclosed related to optimization of visible pixels for surround view and other environment visualizations. For example, systems and methods are disclosed that use a reverse projection to render a visualization through a selected or applicable two-dimensional (2D) viewport and apply image quality processing to the pixels that will be visible in the viewport. The present techniques may be utilized to visualize an environment around an ego-machine, such as a vehicle, robot, and/or other type of object, in systems such as parking visualization systems, surround view systems, and/or others.

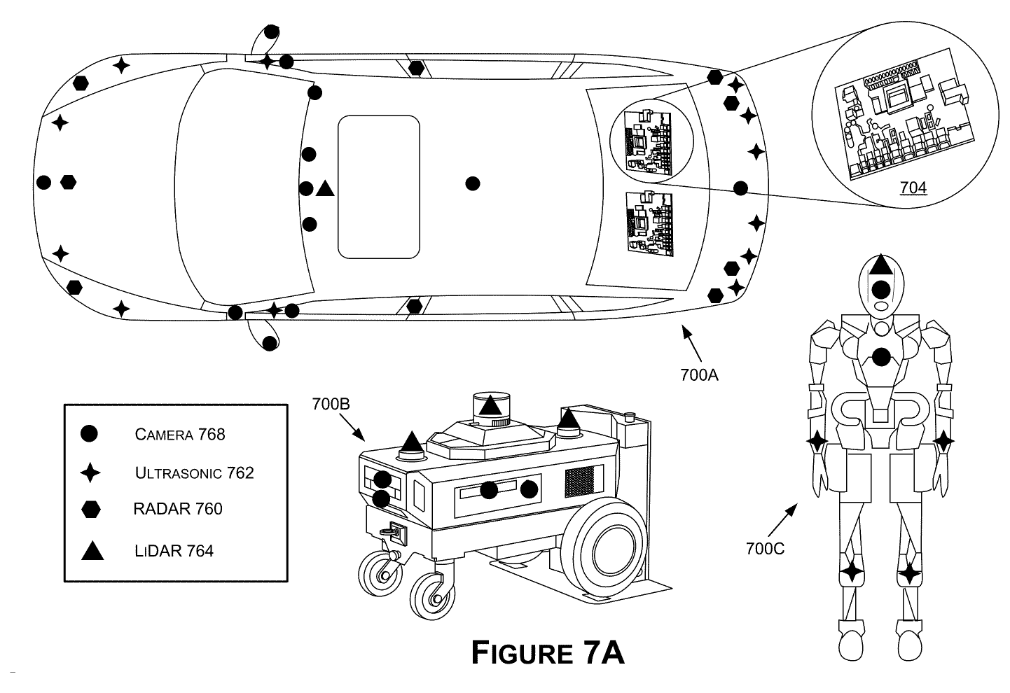

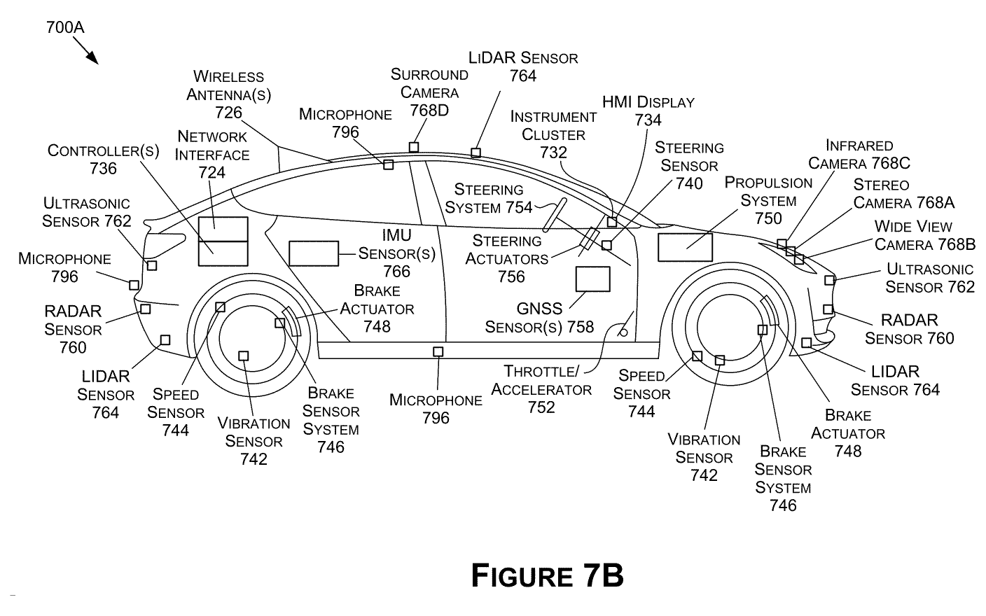

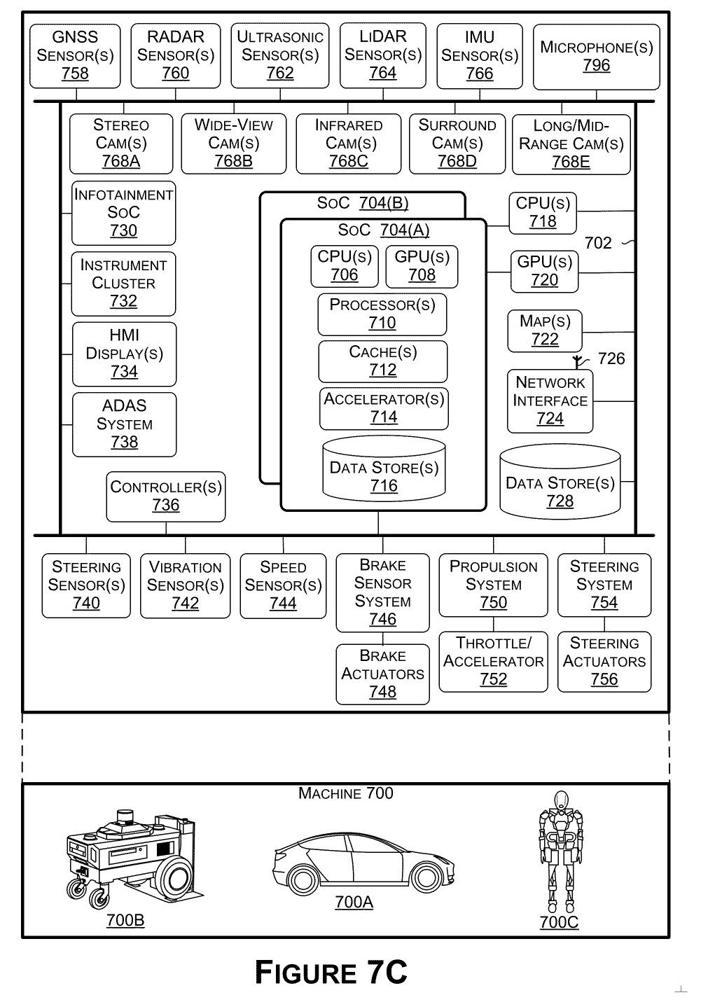

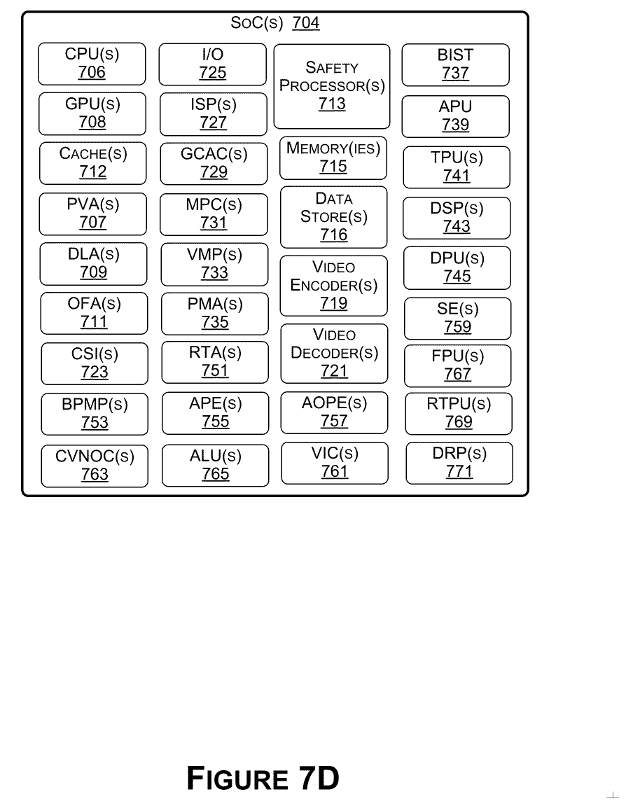

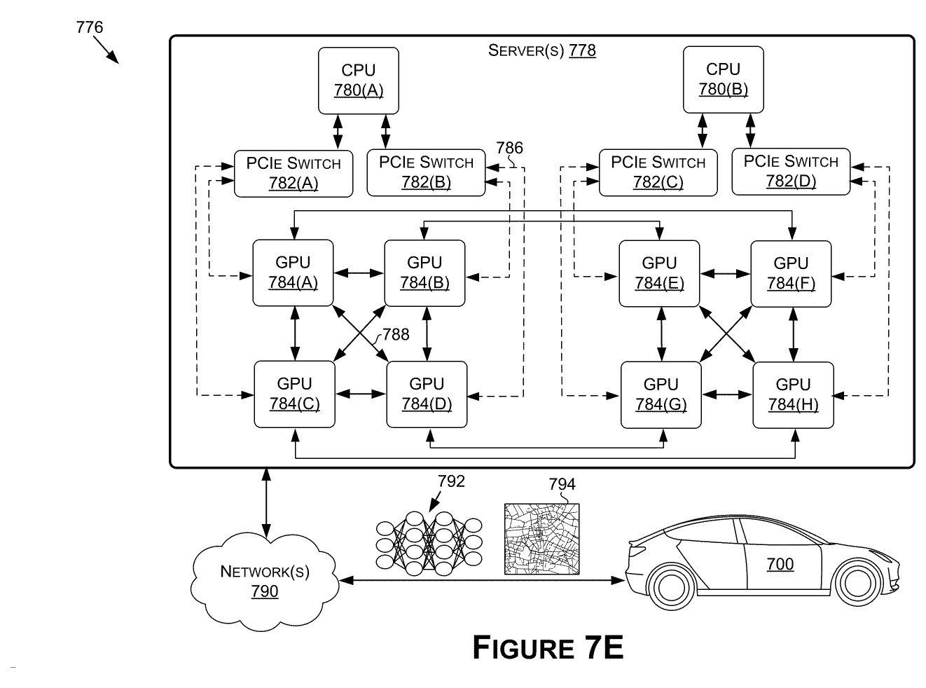

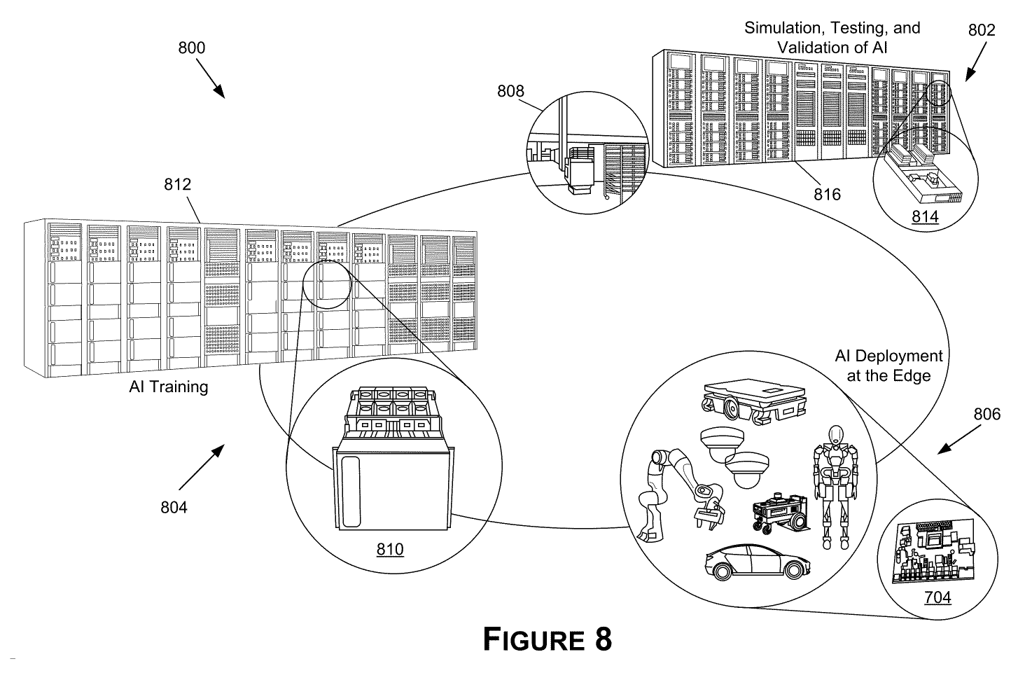

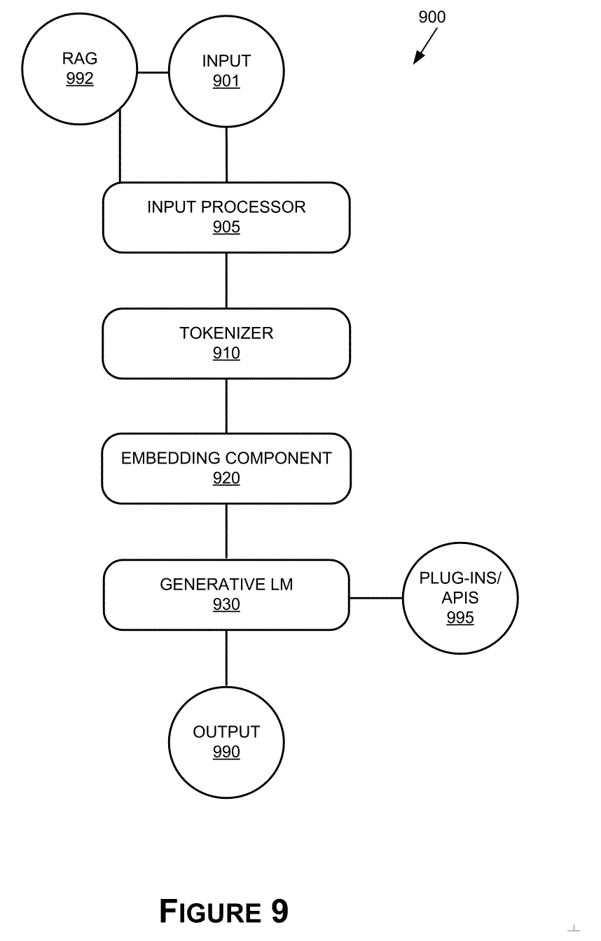

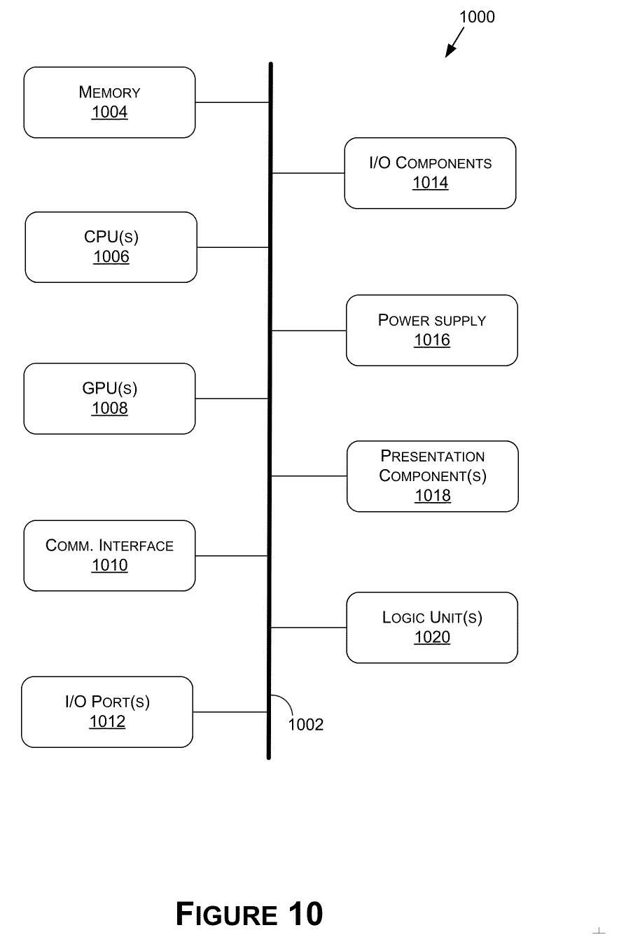

Although the present disclosure may be described with respect to an example autonomous or semi-autonomous vehicle, robot, and/or other machine type 700 (alternatively referred to herein as “vehicle 700,” “ego-vehicle 700,” “machine 700,” “ego-machine 700,” “robot 700,” and/or “ego-robot 700,” an example of which is described with respect to FIGS. 7A-7E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to surround view visualizations for vehicles, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where environment visualization may be used. In some embodiments, the systems, methods, and/or processes described herein may be executed using similar components, features, and/or functionality to those of example machine 700 of FIGS. 7A-7E, example computing ecosystem 800 of FIG. 8, example generative language model system 900 of FIG. 9, and/or example computing device 1000 of FIG. 10.

Environment virtualization techniques often model the environment surrounding an ego-machine using a three-dimensional (3D) shape such as a 3D bowl. For example, an ego-machine may be equipped with cameras pointing in different directions (e.g., mounted at the front, left, rear, and right sides), and the 3D (e.g., bowl) model of the surrounding environment may be used as an intermediate projection surface to map the image data to a 2D view of the environment from the perspective of a virtual camera. For example, a reverse projection may be used to ray-trace each pixel in a selected or applicable 2D viewport (defined by a virtual camera positioned and oriented in a 3D scene with the 3D model of the surrounding environment) to a corresponding intersection point on the surface of the 3D model, map that intersection point to corresponding pixels in the camera images (or some intermediate representation such as a 2D top-down stitched image), and retrieve the corresponding pixel data. Stitching and blending may occur before or after the projection depending on whether an intermediate stitched representation is used. By mapping pixels from the 2D viewport back to the 3D model and retrieving corresponding image data, the reverse projection may be used to avoid projecting pixels from the original images or the intermediate representation that ultimately will be not visible in the applicable 2D viewport.

In contrast to prior techniques that perform certain types of image processing on the full frames of image data generated using the cameras (e.g., after ISP processing), some embodiments perform corresponding image processing (e.g., image quality processing, warping, blending, etc.) on the pixels that are visible in the reverse projection view. Systems and methods are disclosed that use a reverse projection to render a visualization through a selected or applicable two-dimensional (2D) viewport and apply image quality processing to the pixels that will be visible in the viewport. Furthermore, performing certain image processing in the reverse projection view improves image quality over techniques that perform image processing on the full frame of image data for some or all of the original images. For example, conventional image processing techniques typically rely on global parameters derived from a statistical analysis of the entire input image (e.g., brightness, contrast, color histograms, noise levels), but those global parameters are often influenced by parts of the image that will be not visible in the 2D viewport. Taking color adjustment as an example, an image generated using a side-mounted camera may have bright and dark regions. A conventional color adjustment may optimize over the entire scene in the image, including the bright and dark regions. However, if the 2D viewport only sees the dark region, the global parameters computed over the entire input image rarely produce an optimal color adjustment for the subset of the image (e.g., the darker region) appearing in the 2D viewport. Performing image quality operations (e.g., temporal noise reduction, super resolution, anti-aliasing, color adjustment, tone mapping, etc.) on the pixels that are visible in the reverse projection view and omitting those image quality operations on pixels that are outside the viewport results in better image quality.

In some embodiments, the reverse projection process may be used to control or influence one or more image quality operations. For example, the reverse projection process may be used to identify regions of overlapping image data, and temporal noise reduction may be performed differently in those regions—which have twice as much information—than in non-overlapping regions. For example, one possible design choice is to reduce the strength of the temporal noise reduction in overlapping regions. Since overlapping regions are prone to stitching artifacts like ghosting, reducing the strength of the temporal noise reduction in overlapping regions should reduce ghosting artifacts. Another possible design choice is to use stronger filtering which increases sensitivity to movement. Overlapping regions may include image data from cameras with substantially different viewpoints, so it may be beneficial to increase the temporal noise reduction’s sensitivity to movement so that more movement is suppressed. (The availability of twice as much as much reference information in that region should counteract the increased sensitivity). Another possible design choice is to keep the same temporal noise reduction strength and apply twice the noise reduction in overlapping regions.

In some embodiments, multi-camera image processing such as color harmonization may be disabled or simplified based on which cameras have visible pixels in the reverse projection view. Whereas prior techniques perform color harmonization across all surround view images, the reverse projection process may be used to determine which images or which regions in a particular image contribute to the rendered view, and if one image or one region of an image contributes, color harmonization may be disabled. If more than one but less than all the images contribute, color harmonization may be performed across (e.g., the visible portions of) the contributing images. This way, color harmonization may be completely avoided or dramatically simplified. These are just a few examples, and variations may be implemented within the scope of the present disclosure.

Generally, the projection process may result in different levels of magnification in different parts of the reverse projection view depending on the shape of the 3D (e.g., bowl) model, how the image data projects onto the 3D model, and the position and orientation of the virtual camera. As such, the magnification factor or density of input pixels to output pixels (pixel density) may be quantified in regions (e.g., pixels, tiles of pixels) of the reverse projection view, and the resulting regional magnification factor or pixel density may be used to control or influence the image processing in corresponding regions of the reverse projection view. In some embodiments, regional magnification factors or pixel densities may be computed by projecting a dot pattern image through the projection surface to the 2D viewport and measuring the magnification or pixel density in each region (e.g., tile) of the reverse projection view, or by reverse projecting from the 2D viewport to corresponding pixels of the input images and counting how many input pixels map to how many output pixels. As such, a magnification or pixel density map that quantifies the magnification factor or pixel density in each region of the reverse projection view may be generated and used to control or influence image processing (e.g., image quality processing, warping, blending, etc.) in a variety of ways.

For example, in some embodiments, a sampling strategy may be controlled using regional magnification factors or pixel densities in local regions of the reverse projection view. Generally, the reverse projection process may be considered a type of sampling in the sense that it involves mapping discrete points from a 2D image plane back to a 3D space and sampling corresponding pixel values. If the magnification factor in a particular region of the reverse projection view is below one, that region will be zoomed out or shrunk, so downsampling or anti-aliasing may be used in that region (e.g., multiple input pixels may contribute to a single output pixel). If the magnification factor in a particular region of the reverse projection view is above one, that region will be magnified, so upsampling or interpolation may be used in that region (e.g., a single input pixel may be stretched across multiple output pixels). For regions with relatively larger magnification factors, a super resolution algorithm (e.g., Deep Learning Super Sampling (DLSS)) may be applied.

In some embodiments, in regions with a magnification factor less than one where upsampling is performed, regional subsampling may be applied to improve system performance. For example, the projection index during the reverse projection may be subsampled (e.g., by projecting every other pixel coordinate and storing the index in shared memory and interpolating in between) to reduce computational load. More specifically, instead of computing the mapping for every pixel in the reverse projection view, a subset of pixels (e.g., every other pixel) may be projected onto the 3D (e.g., bowl) model, their indices (e.g., 3D coordinates) may be stored, and index interpolation may be applied to estimate the mappings for the remaining pixels based on the projection indices from nearby subsampled pixels instead of performing a full reverse projection for each pixel in that region. This approach may be used to significantly optimize performance by reducing redundant computations while maintaining a smooth and accurate reconstruction of the reverse projection view. Moreover, warping (e.g., fisheye distortion correction) may be considered a form of sampling since it may be used to map pixels from one coordinate system to another and sample values from the original image. In some embodiments, in regions with a magnification factor less than one where upsampling is performed, warping may be performed on subsampled pixels (e.g., by warping every other pixel) and interpolating in between. These are just a few examples, and variations may be implemented within the scope of the present disclosure.

In some embodiments, temporal noise reduction may be controlled using regional magnification factors or pixel densities in local regions of the reverse projection view. In some embodiments, since regions with higher magnification or lower pixel density may end up with magnified noise, stronger temporal noise reduction may be applied in regions with higher magnification or lower pixel density, and vice versa. In another possible design choice, since regions with lower magnifications (e.g., below one) should have correspondingly higher densities of input pixels available, it may be acceptable to downscale the resolution by applying stronger temporal noise reduction on non-textured regions to achieve better noise reduction. For objects or textured regions, weaker temporal noise reduction may be applied since downscaling also downscales the noise level, and keeping a stronger temporal noise reduction level may introduce ghosting artifacts. In some embodiments, spatial filtering and temporal filtering may be blended based on the magnification or pixel density to preserve sharpness or downscale resolution. Since the size of spatial or temporal filters in temporal noise reduction may be considered a form of sampling rate control in the sense that they determine the effective resolution (spatially and temporally) at which noise may be removed and details are preserved, the regional magnification factor or pixel density may be considered to drive the sampling rate.

In some embodiments, color adjustment and/or tone mapping may be controlled using regional magnification factors or pixel densities in local regions of the reverse projection view. Since regional upsampling or downsampling may generate updated color values, color adjustment and/or tone mapping may be performed in each local region, and the results may be blended. For example, if one of the design goals is to maintain high dynamic range and the projection process results in magnification, the projection process may change the image statistics in the visible region. As such, performing color adjustment and/or tone mapping in local regions based on regional magnification factors or pixel densities and blending or interpolating across adjacent tiles should improve image quality.

As such, the techniques described herein may be used to improve visual quality of surround view visualization and other environment visualizations, reduce latency in generating these visualizations, and therefore promote safe operation of the vehicle.

In some embodiments, the systems and methods described herein may be performed within a simulation environment (e.g., NVIDIA’s DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, a visualization of a simulated environment may be generated using simulated input data (e.g., map data, perception data, ego-motion data, tactile data, and/or any other data described herein), and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., a visualization of a simulated environment generated from within the simulation. The synthetic training data (in addition to or alternatively from real-world data) may then be used or processed for training or testing.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA’s RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA’s OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA’s PhysX software developer kit (SDK)), in order to simulate real physics and physical interactions with simulations hosted by the platform. The platform may integrate OpenUSD along with ray tracing/path tracing/light transport simulation (e.g., NVIDIA’s RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to generate a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs) - which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot’s surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs) - which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, one or more machine learning models, entertainment content, navigation data, user preferences, etc.). The system may use these processors to generate or present a visualization of the surrounding environment, and may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice – such an inference microservice (e.g., NVIDIA NIMs) – which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples – such as where the model(s) is large – the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs - such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA’s Triton Inference Server, and/or one or more APIs for high performance deep learning inference, which may include an inference runtime and model optimizations that deliver low latency and high throughput for production applications – such as NVIDIA’s TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA’s Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models – such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

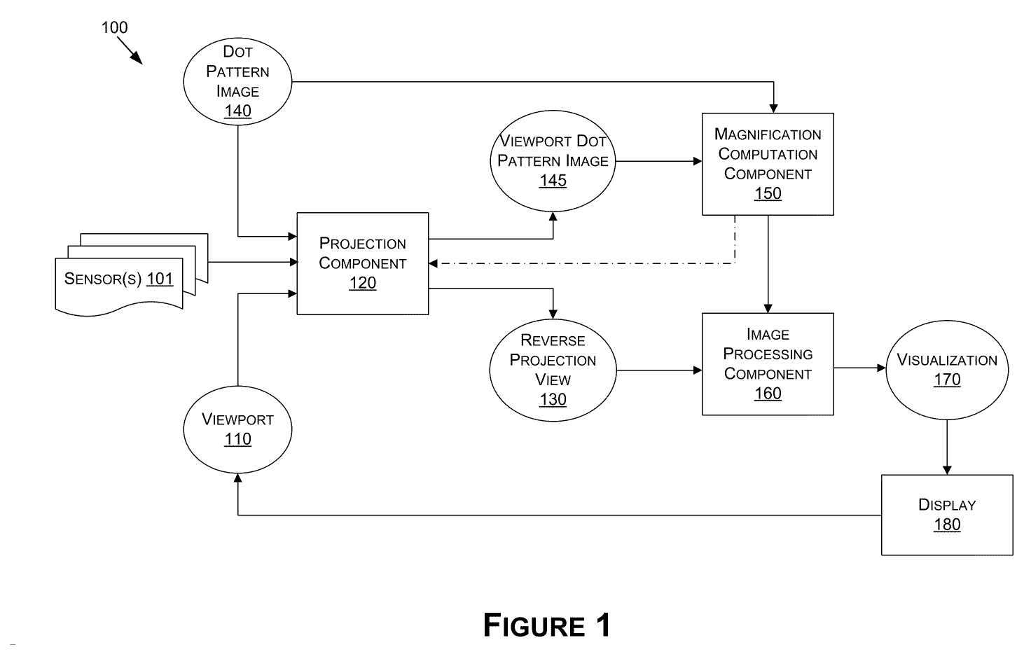

With reference to FIG. 1, FIG. 1 depicts a diagram of an example environment visualization system (e.g., Surround View System 100), in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises – such as locally hosted servers, remotely located – such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 700 of FIGS. 7A-7E, example computing ecosystem 800 of FIG. 8, example generative language model system 900 of FIG. 9, and/or example computing device 1000 of FIG. 10.

At a high level, the Surround View System 100 may be used to generate a visualization 170 of a 3D environment (e.g., around an ego-machine, such as a vehicle) based on frames of image data representing the environment. The Surround View System 100 may be incorporated into an ego-machine such as the vehicle 700 of FIGS. 7A-7D, and may include any number and type of sensor(s) 101 such one or more cameras that generate image data as the ego-machine navigates the 3D environment. Generally, the Surround View System 100 may use the image data (or other sensor data) to generate a surround view visualization representing at least a portion of the surrounding environment. For example, the Surround View System 100 may include a projection component 120 that renders a reverse projection view 130 of the image data through a selected or applicable viewport 110 and an image processing component 160 that applies image processing to the pixels that are visible in the reverse projection view 130. The resulting visualization 170 may be presented on a display 180 visible to an occupant or operator of the ego-machine (e.g., a driver or passenger, a remote operator). As such, the sensor(s) 101 may be used to generate frame(s) of sensor data for each time slice (e.g., at a particular frame rate), and the frame(s) of sensor data for each time slice may be used to generate and/or present a visualization of the surrounding environment on the display 180 (whether at the same frame rate the sensor data is generated or some other frame rate). The Surround View System 100 may operate at any suitable frame rate such that the resulting visualizations form a video stream. Any suitable user interface (e.g., provided by the display 180) may accept input navigating a virtual camera that defines the viewport 110 to different positions or orientations, choosing pre-selected rendering viewports, zooming in or zooming out to focus on specific regions of interest, etc. As such, the Surround View System 100 may update the viewport 110 accordingly and generate a corresponding visualization 170.

More specifically, an ego-machine (e.g., the vehicle 700 of FIGS. 7A-7D) may be equipped with any number and type of sensor(s) 101 (e.g., one or more cameras, such as fisheye cameras), and the sensor(s) 101 may be used to generate frames of overlapping sensor data (e.g., overlapping image data) representing substantially the same time slice. Example sensors that may be used include one or more of the stereo camera(s) 768A, wide-view camera(s) 768B (e.g., fisheye cameras), infrared camera(s) 768C, surround camera(s) 768D (e.g., 360° cameras), and/or long-range and/or mid-range camera(s) 768E of the vehicle 700. In an example configuration, four fisheye cameras may be installed at the front, left, rear, and right sides of a vehicle, and corresponding surrounding videos may be generated at a designated frame rate. An Image Signal Processor (ISP) may be used to perform tasks like noise reduction, auto exposure, white balance, and initial color correction.

Generally, the projection component 120 may use a reverse projection to sample the image data from corresponding sensor(s) 101 and generate a reverse projection view 130 through the viewport 110. For example, the projection component 120 may path-trace pixels from the screen space of the viewport 110 to corresponding intersection points on the surface of a 3D model of the environment (e.g., a 3D bowl), map those intersection points to corresponding pixels in the image data from corresponding sensor(s) 101 (e.g., using a reverse UV mapping), and retrieve or identify image data from corresponding pixels (e.g., color values such as RAW or RGB values, infrared data such as intensity or temperature measurements, image or pixel metadata generated by an Image Signal Processor (ISP) during image capture and/or processing such as exposure levels, exposure corrections, white balance adjustments, initial color correction matrices, etc.). As such, the projection component 120 may store, reference, or otherwise associate the image data with corresponding pixels the reverse projection view 130 (e.g., a 2D image through the viewport 110). Any known technique may be used to generate the 3D model of the environment (e.g., using a fixed 3D bowl, an adaptive 3D bowl such as one that adapts its shape based on distance and/or direction to detected objects, etc.), the viewport 110 may be selected or designated using any known technique (e.g., specified by operator or occupant controlling the virtual camera or selecting from a set of preset viewports via a user interface such as a touch interface provided by the display 180 or a speech interface, selected automatically based on the scenario, etc.).

Depending on the implementation, the Surround View System 100 may perform warping (e.g., fisheye distortion correction), aligning image data from different sensor(s) 101 in a common coordinate system (e.g., one that is defined relative to the ego-machine such as a vehicle rig coordinate system, a global 3D coordinate system or world space), placing stitches, blending at the stitches, and/or other types of image processing in any suitable order, and may occur before the projection component 120 generates the reverse projection view 130 (e.g., in which case, the projection component 120 may sample from warped and/or stitched image data, such as a 2D top-down stitched image) or after the projection component 120 generates the reverse projection view 130 (e.g., in which case, the projection component 120 or the image processing component may perform the warping, alignment, stitch placement, and/or blending in the reverse projection view 130 and may omit corresponding image processing on pixels outside the reverse projection view 130).

In some embodiments, the projection component 120 uses different sampling strategies to sample the image data from the sensor(s) 101 for different regions of the reverse projection view 130. More specifically, the projection component 120 may use regional magnification factors or pixel densities (e.g., quantifying the density of input pixel values or color measurements to the density of output pixels) to control local sampling strategies in local regions of the reverse projection view 130.

In some embodiments, a magnification computation component 150 may compute the regional magnification factors or pixel densities using a dot pattern image 140. More specifically, each of the sensor(s) 101 may be associated with a corresponding instance of the dot pattern image 140, the projection component 120 may generate a corresponding viewport dot pattern image 145 of the dot pattern image 140 for each of the sensor(s) 101 through the viewport 110 (e.g., using forward or reverse projections), and the magnification computation component 150 may compute the regional magnification factors or pixel densities by measuring the dot magnification in different regions of the viewport dot pattern image 145. The dot pattern image 140 may use any suitable dot pattern as a reference (e.g., an equally sized and/or equally spaced dots) and may represent dots and empty space in any suitable way (e.g., using binary values such 1’s to represent dots and 0’s to represent empty space, using different colors to represent dots for different sensor(s) 101, using different colors to represent dots in different fields of view of corresponding sensor(s) 101, etc.).

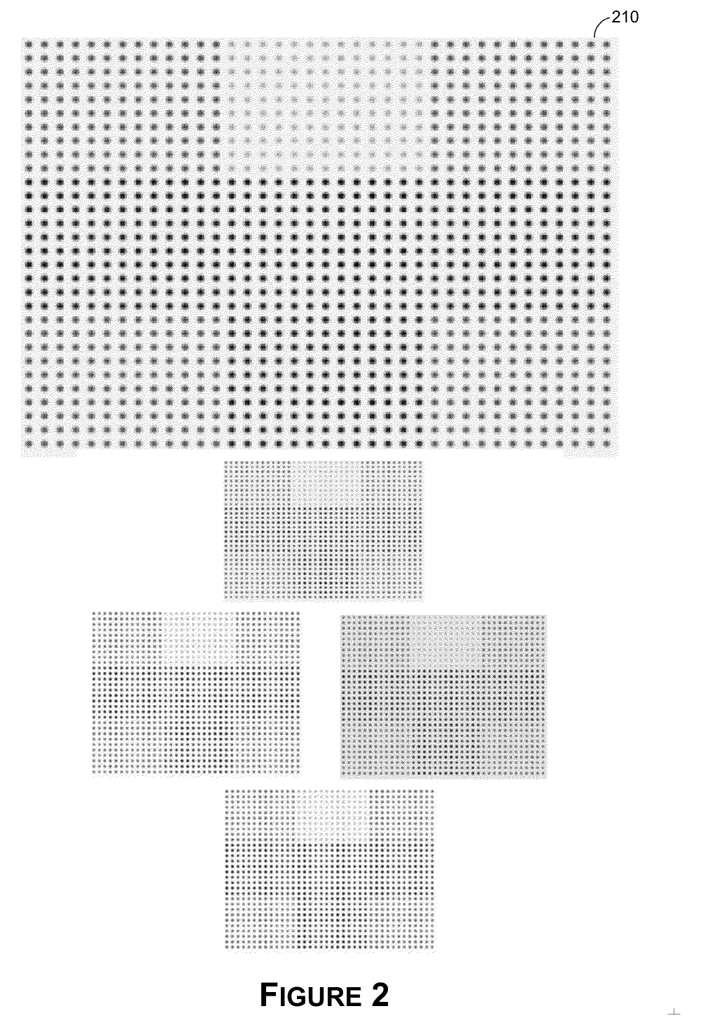

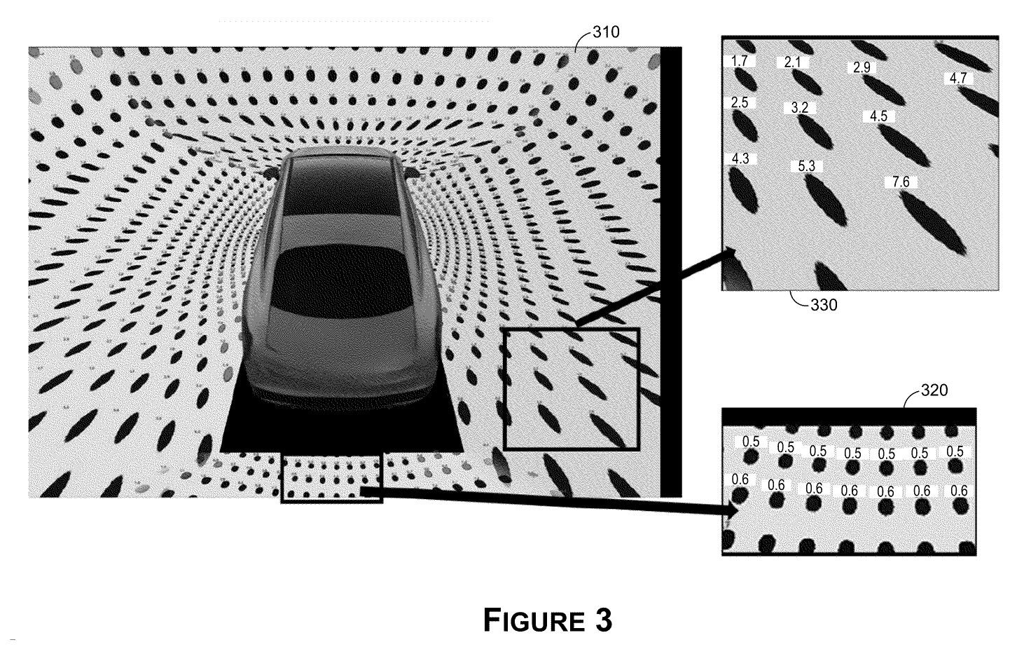

FIG. 2 is an illustration of an example dot pattern image 210, in accordance with some embodiments of the present disclosure. In this example, the dot pattern image 210 has equally spaced and equally sized dots with different colors (illustrated with different shades of grey) in different regions or subdivisions (e.g., in this example, in different cells in a 3×3 grid). The lower half of FIG. 2 illustrates the dot pattern image 210 positioned to represent corresponding images from four surround view cameras (e.g., facing toward the front, left side, back, and right side of an ego-machine) aligned in a common coordinate system. FIG. 3 illustrates how the dot pattern image 210 of FIG. 2 may project from those aligned positions onto an example projection surface such as a 3D bowl 310 (which is included in FIG. 3 for illustration purposes and not necessarily rendered) and some example viewports 320 and 330 with regional magnification factors superimposed on top for illustration purposes. For example, the dots in the viewport 220 which are relatively close to the rear of the car have been magnified by a factor of 0.5 to 0.6 (or downsampled), and the dots in the viewport 230 which are relatively farther from the car have been magnified by a factor of 1.7 to 7.6 (or upsampled).

Returning to FIG. 1, in some embodiments in which the 3D model of the surrounding environment has a fixed shape (e.g., a fixed 3D bowl), the projection component 120 may pre-compute the viewport dot pattern image 145 for preset viewports using that fixed 3D model. In some embodiments in which the shape of the 3D model of the surrounding environment may change, the shape (e.g., the ground plane for the inner portion of the bowl, the top of the outer portion of the bowl) may be parameterized into corresponding ranges of values (e.g., radius, circumference, and/or diameter for a circular bowl; short and long axes, foci, eccentricity, and/or circumference for an ellipse; etc.), and the projection component 120 may pre-compute the viewport dot pattern image 145 for preset viewports using a representative set of parameters for each range.

As such, the magnification computation component 150 may divide the viewport 110 into regions (e.g., pixels, tiles of pixels in a tiled grid such as 16x16 grid), and for each region, the magnification computation component 150 may compute the regional magnification factor or pixel density by comparing dots in corresponding regions of the viewport dot pattern image 145 and the dot pattern image 140. For example, the magnification computation component 150 may use any known technique to detect the area of a dot in a given tile of the viewport dot pattern image 145 and divide that by the known area of the dots in the dot pattern image 140. In a simple example, if the dot pattern image 140 uses single pixel dots and a tile in the viewport dot pattern image 145 has a five-pixel dot, the magnification computation component 150 may divide the areas of the dots to compute a magnification factor of five for that tile. In some embodiments that use different color dots to represent images from different cameras (or different regions of a field of view), the magnification computation component 150 may use any known technique to recognize the color of a dot in a given tile of viewport dot pattern image 145 and recognize which camera (or which portion of its field of view) contributed to the tile. As such, the magnification computation component 150 may repeat the process for each region (e.g., tile) of the viewport dot pattern image 145 to generate a magnification map (or pixel density map) that quantifies the magnification factor (or its inverse the pixel density) in each region of the reverse projection view 130.

In some embodiments (e.g., instead of using a dot pattern image 140 to compute the regional magnification factors or pixel densities), the magnification computation component 150 may coordinate with the projection component 120 to reverse project from the viewport 110 to a corresponding intersection with the 3D model’s surface and retrieve a corresponding region (e.g., patch) from the original image data (e.g., using reverse UV mapping). As such, the magnification computation component 150 may compare the size of a projected patch in the viewport 110 with its corresponding area in the original image data to compute the magnification factor for that region (e.g., how many viewport pixels map to how many camera pixels). As such, the magnification computation component 150 may repeat the process for each region (e.g., tile) of the viewport 110 to generate a magnification map (or pixel density map) that quantifies the magnification factor (or its inverse the pixel density) in each region of the reverse projection view 130.

As such, in some embodiments, the projection component 120 may use the regional magnification factors or pixel densities in the magnification or pixel density map to control sampling in local regions of the reverse projection view 130. For example, the projection component 120 may divide the viewport 110 into regions (e.g., corresponding to the regions of the magnification or pixel density map), and the projection component 120 may perform a reverse projection using a sampling strategy that depends on the magnification factor or pixel density in each region (or the projection component 120 may sample in smaller sub-tiles and interpolate across tiles). For example, if the magnification factor in a particular region of the magnification map is below one (or pixel density is greater than one), a corresponding region of the image data will be zoomed out or shrunken, so the projection component 120 may use downsampling (e.g., averaging) and/or anti-aliasing filtering in that region to prevent loss of detail or aliasing artifacts. Conversely, if the magnification factor in a particular region of the magnification map is above one (or pixel density is less than one), that region will be magnified, so the projection component 120 may use upsampling (e.g., interpolation) in that region to estimate missing pixel values. In some embodiments, if the magnification factor in a particular region of the magnification map is above some designated threshold (e.g., some relatively larger magnification factor such as 2, 5, 10, etc.), the projection component 120 may apply any known super resolution algorithm (e.g., Deep Learning Super Sampling (DLSS) in that region (or the image processing component 160 may apply a super resolution algorithm as a post-processing step).

In some embodiments, in regions with a magnification factor less than one, the projection component 120 may apply regional subsampling. For example, the projection component 120 may subsample the projection index during the reverse projection (e.g., by projecting every other pixel coordinate, storing the index in shared memory, and interpolating in between) to reduce computational load. More specifically, instead of computing the mapping for every pixel in the reverse projection view 130, the projection component 120 may project a subset of pixels (e.g., every other pixel) onto the 3D (e.g., bowl) model, store their indices (e.g., 3D coordinates), and apply index interpolation to estimate the mappings for the remaining pixels based on the projection indices from nearby subsampled pixels. Additionally or alternatively, in regions with a magnification factor less than one, the projection component 120 may apply warping (e.g., fisheye distortion correction) on subsampled pixels (e.g., by warping every other pixel) and interpolating in between.

As such, the projection component 120 may apply a regional sampling strategy in each region of the reverse projection view 130 using corresponding magnification factors or pixel densities computed by the magnification computation component 150, and the projection component 120 (or the image processing component 160) may apply any known blending technique across the resulting regions of the reverse projection view 130. In some embodiments in which the projection component 120 samples from the image data before stitching, the projection process may be used to align image data from corresponding sensor(s) 101 and determine whether there are any regions of overlapping image data (e.g., whether multiple images contributed to the same pixel). As such, the projection component 120 or the image processing component 160 may perform stitch placement and/or blending in the reverse projection view 130.

Generally, the image processing component 160 may perform image quality processing on the pixels that are visible in the reverse projection view 130 (e.g., instead of performing that image processing on the original image data). Some example types of image quality processing which may be applied by the image processing component 160 to the pixels in the reverse projection view 130 include temporal noise reduction, harmonization, color adjustment, and tone mapping. Although the foregoing discussion contemplated some embodiments in which the projection component 120 applies super resolution and/or anti-aliasing as part of the sampling process, the image processing component 160 may additionally or alternatively apply super resolution and/or anti-aliasing as part of the image quality operation(s). Performing image quality operations on the pixels that are visible in the reverse projection view 130 and omitting those image quality operations on pixels that are outside the viewport 110 results in better image quality.

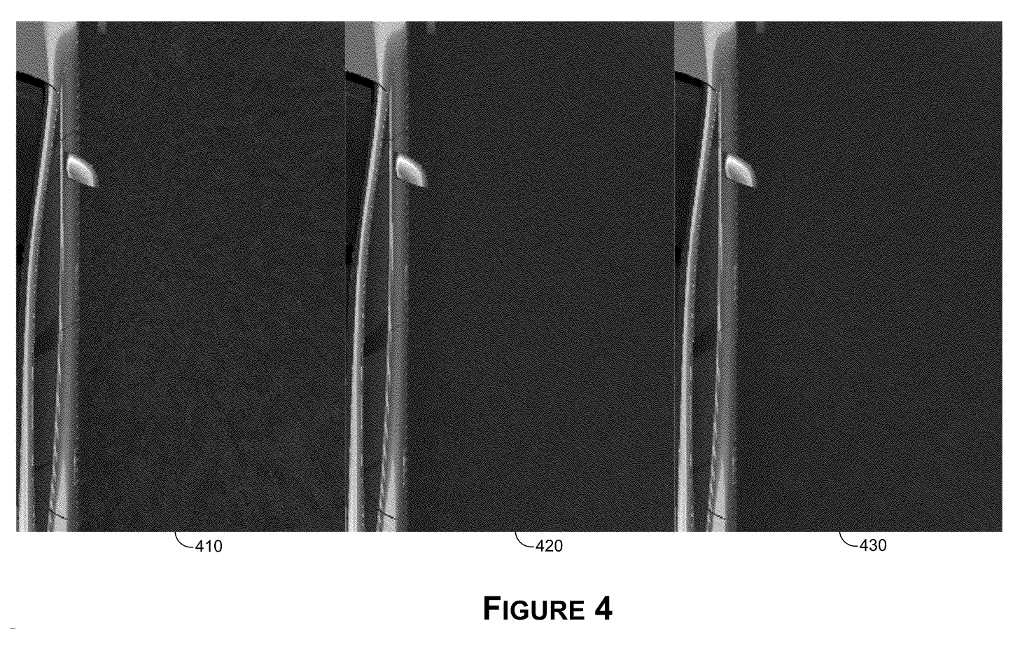

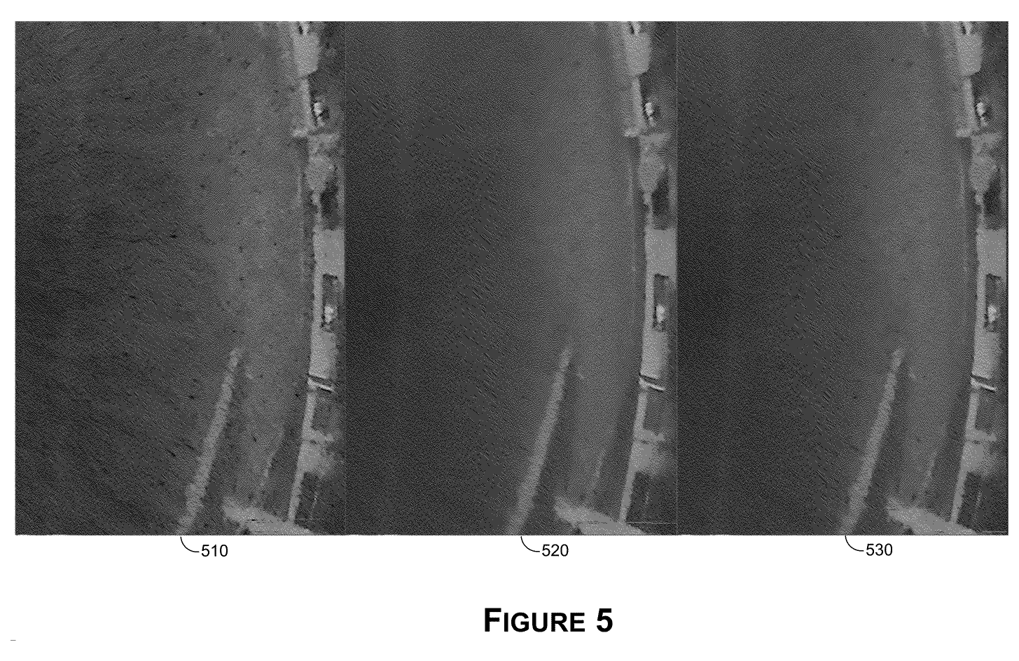

FIGS. 4 and 5 illustrate how applying temporal noise reduction in the viewport may be used to impact image quality, in accordance with some embodiments of the present disclosure. FIG. 4 illustrates three different images of a road surface near a vehicle. Each of the images has a magnification factor below 1 and has pixels that were downsampled from the original fisheye camera images. In the left image 410, temporal noise reduction is off, and the image has substantial noise. In the middle image 420, temporal noise reduction was applied to the original images before the middle image 420 was rendered. Although the noise has been reduced, there is still some noise present. In the right image 430, temporal noise reduction was applied to the rendered viewport, yielding the best result of the three options. FIG. 5 provides another example with three different images of a road surface farther away from the vehicle. Here, each of the images has a magnification factor above 1 and has pixels that were upsampled from the original fisheye camera images. In the left image 510, temporal noise reduction is off, and the image has substantial noise. In the middle image 520, temporal noise reduction was applied to the original images before the middle image 520 was rendered. In the right image 530, temporal noise reduction was applied to the rendered viewport, yielding the best result of the three options.

In some embodiments, the projection component 120 may identify one or more regions of overlapping image data, and the image processing component 160 may apply temporal noise reduction using different parameters inside the region(s) of overlapping image data than it uses outside those regions. For example, the image processing component 160 may identify which regions of the viewport 110 have overlapping image data, and the image processing component 160 may reduce the strength of the temporal noise reduction in the overlapping region(s) to reduce ghosting artifacts. Temporal noise reduction typically includes spatial and temporal filters. Temporal filtering reduces noise by averaging pixel values over multiple frames, whereas spatial filtering smooths noise within a single frame based on neighboring pixels. As such, the image processing component 160 may reduce the strength of the temporal noise reduction in the overlapping region(s) by using a smaller spatial filter window size (defining the area around a pixel within a single frame that contributes to noise reduction) and/or a smaller temporal filter window size (defining the number of past and/or future frames used to refine the pixel’s value over time). In some embodiments, the image processing component 160 may increase the strength of the temporal noise reduction in the overlapping region(s) to suppress more movement.

In some embodiments, the projection component 120 may determine which sensor(s) 101 contribute pixels to the reverse projection view 130 (e.g., which sensor(s) 101 have field(s) of view that are visible through the viewport 110) and may provide the information to the image processing component 160, which may disable or simplify color harmonization based on which sensor(s) 101 contributed pixels. For example, if the reverse projection view 130 comes from a single camera, there is no need to apply color harmonization, and the image processing component 160 may disable it. If more than one but less than all the sensor(s) 101 contributed, the image processing component 160 may apply color harmonization across the corresponding portions of image data in the reverse projection view 130.

By way of example, some example viewports that may be used include an overhead perspective view of a 3D bowl projection (analogous to the 3D bowl 310 of FIG. 3), a top-down plan view with an overhead perspective of the vehicle incorporating portions of four surround-view cameras, a single-camera view providing a feed from any one camera, front and rear triptych or three-panel composite image views with a central panel providing the perspective from a single camera and adjacent panels extend the field of view using partial corrections from side cameras without fully blending them, and a segmented plan view that separately displays a top-down view of the front of the vehicle and a top-down view of the rear of the vehicle. Depending on the viewport (and the camera configuration), the viewport may use image data from one, two, three, or four cameras. Disabling or simplifying color harmonization to only apply to the visible frames should substantially improve the quality and speed of the resulting color harmonization, especially when the color statistics of the visible part of the image are very different from the entire image. Deriving harmonization parameters (e.g., target harmonized mean or standard deviation), a target tone mapping curve, or a target auto white balance (AWB) value from the visible part of an image rather than the entire input image should improve the visual quality of the resulting visualization presented to the user.

In some embodiments, the image processing component 160 may use the regional magnification factors or pixel densities in the magnification or pixel density map to control one or more image quality operations in local regions of the reverse projection view 130. For example, the image processing component 160 may divide the viewport 110 into regions (e.g., corresponding to the regions of the magnification or pixel density map), and the image processing component 160 may perform one or more image quality operations (e.g., temporal noise reduction, color adjustment, tone mapping, etc.) using corresponding parameters that depend on the magnification factor or pixel density in each region (or the image processing component 160 may operate on smaller sub-tiles and interpolate across tiles).

Taking temporal noise reduction as an example, the image processing component 160 may perform temporal noise reduction in regions of the reverse projection view 130 using corresponding regional magnification factors or pixel densities from the magnification or pixel density map. In some embodiments, since regions with higher magnification or lower pixel density may end up with magnified noise, the image processing component 160 may apply stronger temporal noise reduction in regions with higher magnification or lower pixel density, and vice versa. For example, in FIG. 4, each of the images has a magnification factor below 1 (closer to the vehicle), whereas in FIG. 5, each of the images has a magnification factor above 1 (farther from the vehicle). In this example, since upsampling magnifies noise, the image processing component 160 may apply stronger temporal noise reduction to the right image 530 of FIG. 5 than the right image 430 of FIG. 4. In some embodiments, since regions with lower magnifications (e.g., below one) should have correspondingly higher densities of input pixels available, and downsampling usually reduces noise by applying an averaging filter, the image processing component 160 may apply weaker temporal noise reduction and a smaller window size in those regions to reduce or avoid ghosting artifacts in textured/object regions. For smooth regions, the image processing component 160 may apply stronger temporal noise reduction and a larger window size to further reduce the noise level. Additionally or alternatively, the image processing component 160 may blend spatial filtering and temporal filtering and control the ratio of blending based on the magnification or pixel density.

In some embodiments, the image processing component 160 may control the strength of temporal noise filtering based on a determination of whether a region is occupied with objects or textured. Taking some embodiments that use a 3D bowl model to generate a visualization of the environment surrounding a vehicle as an example, lower magnification factors should generally correspond to areas of the ground closer to the vehicle, and those regions may be assumed to be unoccupied and non-textured. As such, the image processing component 160 may determine to apply a stronger temporal noise reduction in regions with lower magnification factors. Conversely, the image processing component 160 may determine to apply a weaker temporal noise reduction in occupied or textured regions to reduce or avoid ghosting or blurring artifacts. The image processing component 160 may assume a region is occupied or textured based on the magnification factor (e.g., greater than one), based on a determination that the region of the reverse projection view 130 is not occupied by a detected object (e.g., detected using any known object detection technique), based on a determination that the region of the reverse projection view 130 depicts the ground (e.g., detected by mapping a ground plane of the 3D bowl model of the surround environment to a corresponding portion of the reverse projection view 130, removing pixels that correspond to detected objects, etc.), and/or any other known technique.

As such, the image processing component 160 may apply temporal noise reduction in local regions of the reverse projection view 130 using different filtering strengths in different regions, and the image processing component 160 may blend the results across regions.

In some embodiments, the image processing component 160 may apply color adjustments in regions of the reverse projection view 130 using corresponding regional magnification factors or pixel densities from the magnification or pixel density map and may blend the results across regions. In some implementations, the projection component 120 may identify which sensor(s) 101 contribute which pixels to the reverse projection view 130 and may provide the information to the image processing component 160, and the image processing component 160 may use corresponding ISP metadata to apply a color adjustment to corresponding regions of the reverse projection view 130. Additionally or alternatively, since magnification may impact the brightness, contrast, and/or color balance, the image processing component 160 may recompute image statistics (e.g., local histograms, contrast, white balance) in each local region, use the recomputed image statistics to adjust the brightness, contrast, and/or color balance in each local region, and blend the results across regions.

In some embodiments, the image processing component 160 may apply tone mapping in regions of the reverse projection view 130 using corresponding regional magnification factors or pixel densities from the magnification or pixel density map. For example, the image processing component 160 may apply local tone mapping in corresponding local regions of the reverse projection view 130 and may blend the results across regions. In some embodiments, the projection component 120 may identify which sensor(s) 101 contribute which pixels to the reverse projection view 130 and may provide the information to the image processing component 160. As a result, the image processing component 160 may use corresponding ISP metadata to process a corresponding region of the reverse projection view 130. In some implementations, the image processing component 160 may adjust the applicable tone curve based on the magnification factor in each local region or may generate separate tone curves for regions with relatively higher or lower magnification factors. As such, the image processing component 160 may use the adjusted or separated tone curves to perform tone mapping (e.g., adjusting the brightness, contrast, exposure, etc.) in each local region, and may blend the results across regions. These are just a few examples, and variations may be implemented within the scope of the present disclosure.

As such, the resulting visualization 170 may be presented on the display 180 (e.g., a monitor, projector, wearable display, etc.) accessible to an occupant or operator of the ego-machine (e.g., a driver or passenger, a remote operator).

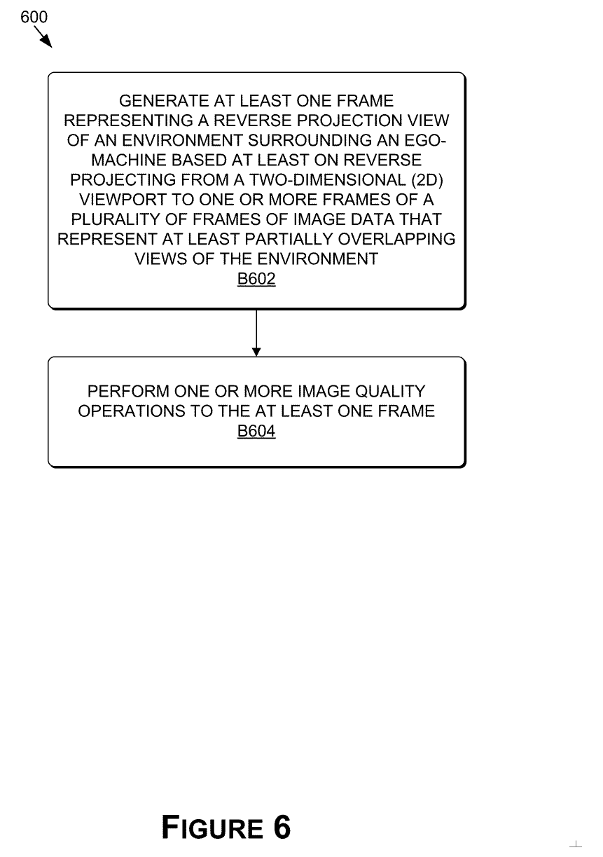

Now referring to FIG. 6, each block of method 600, described herein, comprises a computing process that may be performed using any combination of hardware, firmware, and/or software. For instance, various functions may be carried out by a processor executing instructions stored in memory. The method 600 may also be embodied as computer-usable instructions stored on computer storage media. The method 600 may be provided by a standalone application, a standalone service, a hosted service (standalone or in combination with another hosted service), or a plug-in to another product, to name a few. In addition, the method 600 is described, by way of example, with respect to the Surround View System 100 of FIG. 1. However, these methods may additionally or alternatively be executed by any one system, or any combination of systems, including, but not limited to, those described herein.

FIG. 6 is a flow diagram showing a method 600 for performing one or more image quality operations in a reverse projection view, in accordance with some embodiments of the present disclosure. The method 600, at block B602, includes generating at least one frame representing a reverse projection view of an environment surrounding an ego-machine based at least on reverse projecting from a two-dimensional (2D) viewport to one or more frames of a plurality of frames of image data that represent at least partially overlapping views of the environment. For example, with respect to the Surround View System 100 of FIG. 1, an ego-machine (e.g., the vehicle 700 of FIGS. 7A-7D) may be equipped with any number and type of sensor(s) 101 (e.g., one or more cameras, such as fisheye cameras), and the sensor(s) 101 may be used to generate frames of overlapping sensor data (e.g., overlapping image data) representing substantially the same time slice. In an example configuration, four fisheye cameras may be installed at the front, left, rear, and right sides of a vehicle, and corresponding surrounding videos may be generated at a designated frame rate. An Image Signal Processor (ISP) may be used to perform tasks like noise reduction, auto exposure, white balance, and initial color correction. The projection component 120 may use a reverse projection to sample the image data from corresponding sensor(s) 101 and generate a reverse projection view 130 through the viewport 110. For example, the projection component 120 may ray-trace pixels from the screen space of the viewport 110 to corresponding intersection points on the surface of a 3D model of the environment (e.g., a 3D bowl), map those intersection points to corresponding pixels in the image data from corresponding sensor(s) 101 (e.g., using a reverse UV mapping), and retrieve or identify image data from corresponding pixels. As such, the projection component 120 may store, reference, or otherwise associate the image data with corresponding pixels the reverse projection view 130 (e.g., a 2D image through the viewport 110).

The method 600, at block B604, includes performing one or more image quality operations to the at least one frame. For example, with respect to the Surround View System 100 of FIG. 1, the projection component 120 may use regional magnification factors or pixel densities to control sampling in local regions of the reverse projection view 130 (e.g., upsampling, downsampling, super resolution, anti-aliasing, regional subsampling, warping subsampled pixels, etc.). Additionally or alternatively, the image processing component 160 may perform image quality processing on the pixels that are visible in the reverse projection view 130 (e.g., instead of performing that image processing on the original image data). Some example types of image quality processing which may be applied by the image processing component 160 to the pixels in the reverse projection view 130 include temporal noise reduction, harmonization, color adjustment, and tone mapping.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA’s Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models – such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### EXAMPLE AUTONOMOUS OR SEMI-AUTONOMOUS MACHINE

FIG. 7A is an example of sensor locations having corresponding fields of view or sensory fields for an autonomous or semi-autonomous vehicle 700a, an autonomous mobile robot (AMR) 700b, and a humanoid robot 700c, in accordance with some embodiments of the present disclosure. Although three types of machines 700 are illustrated, this is not intended to be limiting, and the machine(s) 700 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 700a, AMR 700b, humanoid robot 700c, and/or other machine types may be referred to herein collectively as machine 700, in some instances.

With respect to vehicles 700A, autonomous and semi-autonomous vehicles are generally described in terms of automation levels, defined by the National Highway Traffic Safety Administration (NHTSA), a division of the US Department of Transportation, and the Society of Automotive Engineers (SAE) "Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 700 may be capable of functionality in accordance with one or more of Level 3 – Level 5 of the autonomous driving levels. The machine 700 may be capable of functionality in accordance with one or more of Level 1 – Level 5 of the autonomous driving levels. For example, the machine 700 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 700 or other machine, such as being fully autonomous, being highly autonomous, being conditionally autonomous, being partially autonomous, providing assistive autonomy, being semi-autonomous, being primarily autonomous, or other designation.

With respect to FIG. 7A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 768D, a 180 degree field of view of a wide-view camera 770, a 360 degree sensory field of a LiDAR sensor 764, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 700a, AMR 700b, and/or humanoid robot 700c, etc. For example, with respect to the vehicle 700a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 700b and/or humanoid robot 700c, the shape, size, purpose, implementation, model, etc. may dictate the number and types of sensors used.

As illustrated in FIG. 1A, the autonomous or semi-autonomous vehicle 700A, the AMR 700B, and the humanoid robot 700C may include different sensor types, number, and locations. For a non-limiting example, the vehicle 700A may include twelve cameras 764, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 764 may use, in embodiments, a gigabit multimedia serial link (GMSL) interface – such as GMSL2 – as input/output (I/O).

In some embodiments, although not illustrated in FIG. 7A, the vehicle 700A may include an in-cabin occupant and/or driver monitoring system, that may include various different sensors. For example, the in-cabin sensors may include various cameras 768, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 768, the internal camera(s) 768 may, in embodiments, use a GMSL (such as GMSL2) interface for I/O.

As another non-limiting example, the vehicle 700A may further include nine RADAR sensors 760. For example, the vehicle 700A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 760 may use, in embodiments, an Ethernet interface as I/O.

The vehicle(s) 700A may further include, as a non-limiting example, twelve ultrasonic sensors 762. As illustrated in FIG. 7A, the ultrasonic sensors may be positioned along the front and rear bumpers of the vehicle 700A, and along the side of the vehicle 700A, and may be used to detect objects (static and dynamic) in close proximity to the vehicle 700A. In some embodiments, the ultrasonic sensor(s) 762 may use a DS13 interface as I/O.

The vehicle(s) 700A may further include, as a non-limiting example, a LiDAR sensor 764, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 764 may include a 360 degree horizontal FOV or sensory field (such as in a spinning LiDAR sensor) and a 90 degree vertical FOV or sensory field. In some embodiment, the LiDAR sensor(s) 764 may use an Ethernet interface as I/O.

The autonomous mobile robot (AMR) 700B may include, as a non-limiting example, three LiDAR sensors 764. For example, the top-most illustrated LiDAR sensor 764 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 700B may further include, as a non-limiting embodiment, eight cameras 768, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree +- 3 degree FOV), a rear fisheye camera (e.g., 202 degree +- 3 degree FOV), a left fisheye camera (e.g., 202 degree +- 3 degree FOV), and a right fisheye camera (e.g., 202 degree +- 3 degree FOV).

The AMR 700B may further include a charging port, charging port contacts, a status indicator light, one or more (e.g., four) RGB LEDs, one or more IMU sensors 766, a magnetometer, and a barometer. The AMR 700B is capable of high-precision time synchronization between sensors using hardware time stamping, and PTP over Ethernet with less than 10 microseconds for sensor acquisition time. The AMR 700B provides simultaneous camera capture across all cameras 768 within 100 microseconds from a single hardware trigger, in embodiments, and can write to disk at 4GB/second for sensor capture to bag writing (e.g., writing to ROSbags for the robot operation system (ROS)). As such, the AMR 700B is capable of running the ROS (such as NVIDIA’s Isaac ROS), can be teleoperated (as described herein), can map an environment, and can navigate within an environment using visual cameras 768, LiDARs 764, and/or other sensor types or modalities.

The humanoid robot 700C may include, as a non-limiting example, one LiDAR sensor 764. For example, the LiDAR sensor 764 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 700C may further include, as a non-limiting embodiment, four cameras 768, such as a front stereo camera (e.g., 120 degree FOV), a rear stereo camera (e.g., 120 degree FOV), a front fisheye camera (e.g., 202 degree +- 3 degree FOV), and a rear fisheye camera (e.g., 202 degree +- 3 degree FOV).

The humanoid robot 700C may further include, as a non-limiting embodiment, four ultrasonic sensors 762, such as a left arm ultrasonic sensor, a right arm ultrasonic sensor, a left leg ultrasonic sensor, and right leg ultrasonic sensor.

The humanoid robot 700C may further include any number of actuators – such as to allow control and maneuverability of joints. For example, the humanoid robot 700C may include actuators that allow for various degrees of freedom (DoF) depending on the design. In a non-limiting embodiment, the humanoid robot 700C may have 40 total degrees of freedom (DoF) (e.g., 6 DoF x 2 for the arms, 6 DoF x 2 for the hands, 6 DoF x 2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 700C may include position and orientation sensors, such as encoders, gyroscopes, and the like, to determine the position of the robot 700C in space, allowing for location determination and movement tracking. The humanoid robot 700C may include force and pressure sensors, in embodiments, to detect environment interactions, allowing the robot 700C to grasp objects with the right force and to avoid obstacles along the way. The perception sensors (e.g., cameras, LiDARs, RADARs, ultrasonic, SONAR, etc.) may be used along with tactile sensors to allow the robot 700C to perceive objects, shapes, and textures, and to understand when touch is initiated and stopped (along with force sensors that regulate the force used during touch). As a non-limiting example, the humanoid robot 700C may have a height of about 1-2 meters (e.g., 1.7 meters or 5’ 6”), a weight of 50-70 kg, be capable of moving at a speed of 8 or more km/h, and be able to carry payloads anywhere from 20-100 kg, depending on the design and requirements of the system.

The humanoid robot 700C, in embodiments, may include a conversational system – such as a conversational system powered by language models (e.g., LLMs, VLMs, MMLMs, VLAs, etc.) – in order to help understand the environment, reason, and communicate with humans, animals, devices, and/or other robots, and/or make planning, control, and navigation decisions. As such, in addition to performing various tasks, the humanoid robot 700C may use onboard sensors, microphones, and speakers to understanding speech, audio and visual cues, etc., while also being able to communicate back to the environment.

With reference to cameras 768 of the machine(s) 700, the camera types for the cameras 768 may include, but are not limited to, digital cameras that may be adapted for use with the components and/or systems of the machine 700. For a vehicle 700a implementation, the camera(s) 768 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 768B that may be used to perceive objects coming into view from the periphery (e.g., pedestrians, warehouse vehicles, other robots, crossing traffic, or bicycles). In addition, any number of long-range camera(s) 768E (e.g., a long-view stereo camera pair) may be used for depth-based object detection, especially for objects for which a neural network has not yet been trained. The long-range camera(s) 768E may also be used for object detection and classification, as well as basic object tracking.

Any number of stereo cameras 768A may also be included in a front-facing and/or other (e.g., rear-facing) configuration. In at least one embodiment, one or more of stereo camera(s) 768A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine’s 700 environment, including a distance estimate for points in the image (e.g., a disparity or depth image). An alternative stereo camera(s) 768A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 700 (e.g., side-view cameras) may be used, for example, for surround view, providing information used to create and update the occupancy grid, as well as to generate side impact collision warnings and/or to indicate to an AMR 700B or humanoid robot 700C, for example, that there are objects, features, and/or persons present to the side. For example, surround camera(s) 768D may be positioned on the machine 700. The surround camera(s) 768D may include wide-view camera(s) 768B, fisheye camera(s), 360 degree camera(s), and/or the like. For example, four fisheye cameras may be positioned on the machine’s 700 front, rear, and sides. In an alternative arrangement, the machine 700 may use three surround camera(s) 768D (e.g., left, right, and rear), and may leverage one or more other camera(s) (e.g., a forward-facing camera) as a fourth surround view camera.

Cameras 768 with a field of view that include portions of the environment to the rear of the machine 700 (e.g., rear-view cameras) may be used for gaining an understanding of objects, features, persons, and/or other information to the rear of the machine 700, such as for park assistance, surround view, rear collision warnings, planning, control, and navigation determinations, and/or creating and updating an occupancy grid, BEV image representing the environment, height map, etc. A wide variety of cameras 768 may be used including, but not limited to, cameras 768 that are also suitable as a front-facing camera(s) (e.g., long-range and/or mid-range camera(s) 768E, stereo camera(s) 768A), infrared camera(s) 768C, etc.), rear-facing camera(s), side-facing camera(s), downward facing camera(s), upward facing camera(s), and/or the like, as described herein.

Similarly, for LiDAR sensors 764, RADAR sensors 760, ultrasonic sensors 762, and/or other sensor modalities or types, the location and placement of the sensors, and their corresponding fields of view or sensory fields may be determined based on the use case, implementation, or design of the particular machine 700.

For example, the machine(s) 700 include RADAR sensor(s) 760 that may be used by the machine 700 for long-range object detection, even in darkness and/or severe weather conditions. RADAR functional safety levels may be ASIL B, in embodiments. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250m range. The RADAR sensor(s) 760 may help in distinguishing between static and moving objects, and may be used by ADAS systems for emergency brake assist and forward collision warning, by robots for detecting dynamic objects in various environments – such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine’s 700 surroundings at higher speeds with minimal interference from the periphery (e.g., from traffic in adjacent lanes). The other two antennae may expand the field of view, making it possible to quickly detect objects entering or leaving the machine’s immediate path (e.g., lane).

Mid-range RADAR systems may include, as an example, a range of up to 760m (front) or 80m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 700 (e.g., vehicle, robot, etc.). As such, short-range RADAR systems may be used in an ADAS system for blind spot detection and/or lane change assist.

The machine 700 may further include ultrasonic sensor(s) 762. The ultrasonic sensor(s) 762, which may be positioned at the front, back, and/or the sides of the machine 700, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 700. A wide variety of ultrasonic sensor(s) 762 may be used, and different ultrasonic sensor(s) 762 may be used for different ranges of detection (e.g., 2.5m, 4m). The ultrasonic sensor(s) 762 may operate at functional safety levels of ASIL B, as an example.

The machine 700 may include LiDAR sensor(s) 764. The LiDAR sensor(s) 764 may be used for object and feature detection, pedestrian and other robot detection, emergency braking, collision avoidance, simultaneous localization and mapping (SLAM), free-space detection, and/or other functions. The LiDAR sensor(s) 764 may be functional safety level ASIL B, in embodiments. In some examples, the machine 700 may include multiple LiDAR sensors 764 (e.g., two, four, six, etc.) that may use Ethernet (e.g., to provide data to a Gigabit Ethernet switch).

In some examples, the LiDAR sensor(s) 764 may be capable of providing a list of objects and their distances for a 360-degree field of view. Commercially available LiDAR sensor(s) 764 may have an advertised range of approximately 700m, with an accuracy of 2cm-3cm, and with support for a 700Mbps Ethernet connection, for example. In some examples, one or more non-protruding LiDAR sensors 764 may be used. In such examples, the LiDAR sensor(s) 764 may be implemented as a small device that may be embedded into the front, rear, sides, top, and/or corners of the machine 700. The LiDAR sensor(s) 764, in such examples, may provide up to a 120-degree horizontal and 35-degree vertical field-of-view, with a 200m range even for low-reflectivity objects. Front-mounted LiDAR sensor(s) 764 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 700. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 764 may be less susceptible to motion blur, vibration, and/or shock.

FIG. 7B is an illustration of sensor and component locations of an example autonomous or semi-autonomous vehicle 700A (alternatively referred to herein as “vehicle 700,” “ego-vehicle 700,” “ego-machine 700,” or “machine 700,”), in accordance with some embodiments of the present disclosure. Although the vehicle 700A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 7C is a block diagram of an example system architecture for a machine 700, such as autonomous or semi-autonomous vehicle 700A, autonomous mobile robot (AMR) 700B, humanoid robot 700C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises – such as locally hosted servers, remotely located – such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 700 of FIGS. 7A-7E, example computing ecosystem 800 of FIG. 8, example generative language model system 900 of FIG. 9, and/or example computing device 1000 of FIG. 10.

Each of the components, features, and systems of the machine 700 in FIG. 7C are illustrated as being connected via bus 702 (alternatively referred to as a “machine communications network 702,” or just “communications network 702”). The bus 702 may include a Controller Area Network (CAN) data interface (alternatively referred to herein as a “CAN bus”). A CAN may be a network inside the machine 700 used to aid in control of various features and functionality of the machine 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 702 may include FlexRay, an embedded bus (e.g., SPI, I2C), local interconnect link (LIN), NVIDIA’s NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the machine 700, and two or more busses 702 may communicate with the same components. In some examples, each SoC 704, each controller 736, and/or each computer or compute engine within the machine 700 may have access to the same input data (e.g., inputs from sensors of the machine 700), and may be connected to a common bus, such as a CAN bus.

The machine 700 may include components such as a chassis, a vehicle body, wheels (e.g., 2, 4, 6, 8, 18, etc.), tires, axles, batteries, side-view mirrors, and/or other components of a vehicle or machine. The machine 700 may include a propulsion system 750, such as an internal combustion engine, hybrid electric power plant, an all-electric engine, a hydrogen-fueled engine, and/or another propulsion system type. The propulsion system 750 may be connected to a drive train of the machine 700, which may include a transmission, to enable the propulsion of the machine 700. The propulsion system 750 may be controlled in response to receiving signals from the throttle/accelerator 752.

A steering system 754, which may include a steering wheel and/or other steering device (e.g., remote steering and/or local steering), may be used to steer the machine 700 (e.g., along a desired path or route) when the propulsion system 750 is operating (e.g., when the vehicle is in motion). The steering system 754 may receive signals from a steering actuator 756. In some embodiments, a steering wheel or other steering mechanism may not be included, such as for a machine 700 capable of full automation (e.g., Level 5) functionality.

The brake sensor system 746 may be used to operate the vehicle brakes in response to receiving signals from the brake actuators 748 and/or brake sensors.

The machine 700 may include one or more controller(s) 736, such as those described herein with respect to FIG. 7A. The controller(s) 736 may be used for a variety of functions, and may be coupled to any of the various other components and systems of the machine 700. For example, the controllers 736 may be used for control of the machine 700, artificial intelligence executing on the machine 700, infotainment for the machine 700, and/or the like. For example, one controller 736 may be used for some or all of the functionality, or different controllers 736 may be used for different functionalities – e.g., to ensure availability and a safety separation between various controllers for different tasks. For example, the controller(s) 736 may use plans computed by the system – e.g., paths or trajectories for vehicles 700A or AMRs 700B, or movements, components trajectories, movement locations or displacements, etc. for joints or components (e.g., of manipulators, end effectors, limbs, hands, fingers, legs, feet, etc.), of a humanoid robot 700C – to control the machine(s) 700 in the environment. In some instances, the controller(s) 736 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 700C, for example, the controller(s) 736 may act as the brain, responsible for analyzing sensor data, making decisions, and sending commands to the actuators. The controller(s) 736 may include a low-level controller that handles basic motor control, ensuring accurate and precise movements of individual joints and actuators. The controller(s) 736 may include a high-level controller to coordinate multiple actuators and sensors, planning complex motions and adapting to changing environments.

The controller(s) 736 may include an artificial intelligence controller, in embodiments, that may use AI algorithms (e.g., DNNs, MLMs, etc.) to learn, make decisions, and autonomously perform tasks for the machine 700. In some embodiments, the controller(s) 736 may use an open-loop control algorithm that is fixed and does not adjust actions to the environment. In other embodiments, closed-loop control may be used that incorporates feedback mechanisms to monitor the robot’s performance and make necessary adjustments. In examples, the controller(s) 736 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 736, which may include one or more systems on chip (SoCs) 704 (FIG. 7C and 7D), CPUs, GPU(s), accelerator(s), etc., may provide signals (e.g., representative of commands or messages) to one or more components and/or systems of the machine 700. Although the controller(s) 736 is listed separately from the SoC(s) 704, this is not intended to be limiting, and in some embodiments one or more components of the SoC(s) 704 may perform the operations of the controller(s) 736. For example, the controller(s) may send signals to operate the machine brakes via one or more brake actuators 748, to operate the steering system 754 via one or more steering actuators 756, to operate the propulsion system 750 via one or more throttle/accelerators 752, etc. The controller(s) 736 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 700. The controller(s) 736 may include a first controller 736 for autonomous control and navigation functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 736 may handle two or more of the above functionalities, two or more controllers 736 may handle a single functionality, and/or any combination thereof.

The controller(s) 736 may provide the signals for controlling one or more components and/or systems of the machine 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LiDAR sensor(s) 764, inertial measurement unit (IMU) sensor(s) 766 (e.g., accelerometer(s), gyroscope(s), magnetic compass(es), magnetometer(s), etc.), microphone(s) 796, camera(s) 768 (e.g., stereo camera(s) 768A, wide-view camera(s) 768B (e.g., fisheye cameras), infrared camera(s) 768C, surround camera(s) 768D (e.g., 360 degree cameras), long-range and/or mid-range camera(s) 768E, and/or other camera types), speed sensor(s) 744 (e.g., for measuring the speed of the machine 700), vibration sensor(s) 742, steering sensor(s) 740, brake sensor(s) (e.g., as part of the brake sensor system 746), actuators, and/or other sensor types.

One or more of the controller(s) 736 may receive inputs (e.g., represented by input data) from an instrument cluster 732 of the machine 700 and provide outputs (e.g., represented by output data, display data, etc.) via a human-machine interface (HMI) display 734 (e.g., screen, heads-up display, mirror display, facial display, robotic display, etc.), an audible annunciator, a loudspeaker, a speaker, and/or via other components of the machine 700. The outputs may include information such as machine velocity, speed, time, map data corresponding to a map(s) 722 of FIG. 7C (e.g., from a navigation map, a Standard Definition (SD) map, a High Definition (“HD”) map, etc.), location data (e.g., the machine’s 700 location, such as on a map 722), direction, location of other vehicles (e.g., an occupancy map, height map, bird’s eye view (BEV) image, grid, etc.), information about objects and status of objects as perceived by the system, system status information, etc. For example, the HMI display(s) 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 700 may include one or more systems on a chip (SoCs) 704 (described in more detail in FIG. 7D). The SoC(s) 704 may include CPU(s) 706, GPU(s) 708, processor(s) 710, cache(s) 712, accelerator(s) 714, data store(s) 716, and/or other components and features. The SoC(s) 704 may be used to process and provide data for various operations, such as navigation, planning, reasoning, inference, perception, control, and/or actuation operations of the machine 700 in a variety of platforms and systems. For example, the SoC(s) 704 may process live perception data (e.g., from camera, LiDAR, RADAR, ultrasonic, etc.) in addition to map data corresponding to one or more maps 722 (e.g., HD map, SD map, navigational map, occupancy map, etc.) in order to make or aid in performing various operations of the machine 700. Where a map and/or AI is used, map and/or AI (e.g., model parameter updates, fine-tuning, etc.) refreshes and/or updates via a network interface 724 from one or more servers (e.g., server(s) 778 of FIG. 7E) – such as one or more servers of a cloud-based data center.

Although an SoC(s) 704 is illustrated throughout FIGS. 7A-7E, additional or alternative components and/or architectures may be used – such as multi-chip modules (MCMs), application-specific integrated circuits (ASICs), system-in-packages (SiPs), field programmable gate arrays (FPGAs), heterogeneous integration (HI), single-board computers (SBCs) – without departing from the scope of the present disclosure. For example, depending on the type of machine 700, use of the machine 700, model of the machine 700, and required capabilities of the machine 700, one or more SoCs 704 and/or alternative architectures and/or components may be used to satisfy the particular implementation.

The machine 700 may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The machine 700 may include a GPU(s) 720 (e.g., discrete GPU(s), or dGPU(s)), that may be coupled to the SoC(s) 704 via a high-speed interconnect (e.g., NVIDIA’s NVLink). The GPU(s) 720 may provide additional artificial intelligence functionality, such as by executing redundant and/or different neural networks, and may be used to train and/or update neural networks based on input (e.g., sensor data) from sensors of the machine 700.

The machine 700 may further include the network interface 724 which may include one or more wireless antennas 726 and/or modems (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 700 information about vehicles in proximity to the machine 700 (e.g., vehicles in front of, on the side of, and/or behind the machine 700). This functionality may be part of a cooperative adaptive cruise control functionality of the machine 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The machine 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The machine 700 may further include IMU sensor(s) 766. The IMU sensor(s) 766 may be located at a center of the rear axle of the machine 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the machine 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include one or more microphone 796 placed in and/or around the machine 700. The microphone(s) 796 may be used for emergency vehicle detection and identification, among other things.

The machine 700 may further include vibration sensor(s) 742. The vibration sensor(s) 742 may measure vibrations of components of the machine, such as the arms or legs of a humanoid robot 700C, or the axle(s) of a vehicle 700A or AMR 700B. For example, changes in vibrations may indicate a change in road, walking, or traversable surfaces. In another example, when two or more vibration sensors 742 are used, the differences between the vibrations may be used to determine friction or slippage of the surface (e.g., when the difference in vibration is between a power-driven axle and a freely rotating axle).

The machine 700 may include an ADAS system 738 – such as when the machine 700 is a vehicle 700A. The ADAS system 738 may include a dedicated SoC(s), in some examples. The ADAS system 738 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 700 may further include the infotainment SoC 730 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the machine 700. In some examples, the infotainment SoC 730 may be coupled to a supervisory MCU such that the GPU of the infotainment system may perform some self-driving functions in the event that the primary controller(s) 736 (e.g., the primary and/or backup computers of the machine 700) fail. In such an example, the infotainment SoC 730 may put the machine 700 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models – such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 700 – whether a vehicle 700A, AMR 700B, humanoid robot 700C, and/or other type of machine – may include a locally stored language model(s) and/or communicate to a remotely hosted language model (e.g., via one or more APIs) to provide more detailed and in-depth communication features to the users of the machine(s) 700.

In some examples, an infotainment SoC 730, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In some embodiments, an in-cabin monitoring camera sensor may be monitored using one or more neural networks running on another or dedicated SoC – such as an in-vehicle infotainment or in-vehicle monitoring SoC, configured to identify in cabin events and respond accordingly. An in-cabin system may perform lip reading to activate cellular service and place a phone call, dictate emails, change the vehicle’s destination, activate or change the vehicle’s infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 700.

The machine 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a block diagram of an example architecture of a computing system (a subset of the system described with respect to FIG. 7C), in accordance with at least some embodiments of the present disclosure. Although illustrated as an SoC(s) 704, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 704 may be an end-to-end platform with a flexible architecture that spans automation levels 2-5, or the SoC(s) 704 may be specifically designed for a specific automation level (e.g., a first SoC 704 for level 2 to level 2++, a second SoC 704 for level 3, a third SoC 704 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 2-5 autonomous vehicles as well as for safe planning, navigation, and control of AMRs 700B, humanoid robots 700C, and/or other robot or machine types.

In some embodiments, such as where the SoC(s) 704 include a GPU 708 with 2000 or more cores (e.g., 2048 cores), 60 or more tensor cores (e.g., 64 tensor cores), and a GPU max frequency of over 1 GHz (e.g., 1.3 GHz), a CPU 706 including 10 or more cores (e.g., 12 cores), with 64 bits, 3MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 709 (e.g., 2 DLAs/XNNs/NNAs/NPUs 709), and a vision accelerator – such as a programmable vision accelerator (PVA) 707, a single SoC 704) may be capable of 275 tera operations per second (TOPS) of AI performance. For example, NVIDIA’s Jetson AGX Orin 64 GB SoC satisfies these criteria, and achieves this performance.

Similarly, in embodiments where the SoC(s) 704 include a GPU 708 with 1700 or more cores (e.g., 1792 cores), 50 or more tensor cores (e.g., 56 tensor cores), and a GPU max frequency of over 900 MHz (e.g., 930 MHz), a CPU 706 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 709 (e.g., 2 DLAs/XNNs/NNAs/NPUs 709), and a vision accelerator – such as a programmable vision accelerator (PVA) 707, a single SoC 704) may be capable of 200 tera operations per second (TOPS) of AI performance. For example, NVIDIA’s Jetson AGX Orin 32 GB SoC satisfies these criteria, and achieves this performance.

In some embodiments, such as where the SoC(s) 704 include a GPU 708 with 1000 or more cores (e.g., 1024 cores), 28 or more tensor cores (e.g., 32 tensor cores), and a GPU max frequency of over 900 MHz (e.g., 1173 MHz), a CPU 706 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 709 (e.g., 1 DLA/XNN/NNA/NPU 709), and a vision accelerator – such as a programmable vision accelerator (PVA) 707, a single SoC 704) may be capable of 157 tera operations per second (TOPS) of AI performance. For example, NVIDIA’s Jetson AGX Orin NX 16 GB SoC satisfies these criteria, and achieves this performance.

In various embodiments, such as where the SoC(s) 704 include a GPU 708 with 1000 or more cores (e.g., 1024 cores), 28 or more tensor cores (e.g., 32 tensor cores), and a GPU max frequency of over 900 MHz (e.g., 1020 MHz), a CPU 706 including 6 or more cores (e.g., 6 cores), with 64 bits, 1.5 MB L2 and 4 MB L3 cache memory, and a max frequency of 1.5 or more GHz (e.g., 1.7 GHz), a single SoC 704) may be capable of 67 tera operations per second (TOPS) of AI performance. For example, NVIDIA’s Jetson Orin Nano 8 GB SoC satisfies these criteria, and achieves this performance.

The SoC(s) 704 may include one or more CPUs 706. The CPU(s) 706 may include a CPU cluster or CPU complex (alternatively referred to herein as a “CCPLEX”), in embodiments. The CPU(s) 706 may include multiple cores and/or (e.g., L2, L3) caches. For example, in some embodiments, the CPU(s) 706 may include twelve cores in a coherent multi-processor configuration. In some embodiments, the CPU(s) 706 may include four dual-core clusters where each cluster has a dedicated L2 cache (e.g., a 3 MB L2 cache). The CPU(s) 706 (e.g., the CCPLEX) may be configured to support simultaneous cluster operation enabling any combination of the clusters of the CPU(s) 706 to be active at any given time.

The SoC(s) 704 may include any type and number of GPUs 708. For example, an integrated GPU(s) (alternatively referred to herein as an “iGPU(s)”) may be used in some embodiments. The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include a cache (e.g., an L1 cache with at least 96KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA’s CUDA).

The GPU(s) 708 may be power-optimized for best performance in automotive, robotics, and/or other embedded use cases. For example, the GPU(s) 708 may be fabricated on a Fin field-effect transistor (FinFET). However, this is not intended to be limiting and the GPU(s) 708 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

The SoC(s) 704 may include any number of cache(s) 712, including those described herein. For example, the cache(s) 712 may include L0 caches, L1 caches, L2 caches, L3 caches (e.g., that are available to both the CPU(s) 706 and the GPU(s) 708 (e.g., that is connected both the CPU(s) 706 and the GPU(s) 708)), etc. The cache(s) 712 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 704 may include one or more arithmetic logic units (ALUs) 765 which may be leveraged in performing processing with respect to any of the variety of tasks or operations of the machine 700 – such as computer vision, machine learning or deep learning processing, world model management, etc. In addition, the SoC(s) 704 may include a floating point unit(s) (FPU(s)) 767 – or other math coprocessor or numeric coprocessor types – for performing mathematical operations within the system. For example, the SoC(s) 104 may include one or more FPUs 767 integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory 715 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 714 (e.g., the hardware acceleration cluster) may include a deep learning accelerator(s) (DLA) 709 (alternatively referred to herein as “a deep learning accelerator cluster (XNN) 709,” “neural network accelerator (NNA) 709,” or “neural processing unit (NPU) 709”). The DLA(s) 709 may include one or more Tensor processing units (TPUs) 741 that may be configured to provide an additional, e.g., ten trillion operations per second for deep learning applications and inferencing. The TPUs 741 may be accelerators configured to, and optimized for, performing image processing functions (e.g., for CNNs, RCNNs, DNNs, etc.). The DLA(s) 709 may further be optimized for a specific set of neural network types and floating point operations, as well as inferencing. The design of the DLA(s) may provide more performance per millimeter than a general-purpose GPU, and vastly exceeds the performance of a CPU. The TPU(s) 741 may perform several functions, including a single-instance convolution function, supporting, for example, INT8, INT16, and FP16 data types for both features and weights, as well as post-processor functions. Although the TPU(s) 741 are described as being included as part of the DLA(s) 709, this is not intended to be limiting, and the TPU(s) 741 may be included in additional or alternative accelerator(s) 714 and/or other components, and/or may be included as a discrete processing component(s).

The DLA(s) 709 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 709 may perform any function of the GPU(s) 708, and by using an inference accelerator, for example, a designer may target either the DLA(s) 709 or the GPU(s) 708 for any function. For example, the designer may focus processing of DNNs and floating point operations on the DLA(s) 709 and leave other functions to the GPU(s) 708 and/or other accelerator(s) 714. The DLA(s) 709 may be used to run any type of network to enhance control and safety, including for example, a neural network that outputs a measure of confidence for each object detection.

The accelerator(s) 714 (e.g., the hardware acceleration cluster) may include a programmable vision accelerator(s) (PVA) 707, which may alternatively be referred to herein as a computer vision accelerator or generally a vision accelerator. The PVA(s) 707 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 707 may provide a balance between performance and flexibility. For example, each PVA(s) 707 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 707 may be optimized for the tasks of image processing and computer vision algorithm acceleration. For example, the PVA(s) 707 provides excellent performance with extremely low power consumption, and can be used asynchronously and concurrently with the CPU(s) 706, GPU(s) 708, and/or other accelerators in the system (e.g., vehicle, robot, etc.) as part of a heterogeneous compute pipeline.

The PVA(s) 707 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 743 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts – ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 706 (e.g., ARM Cortex-R5 processor), facilitating data exchange with the CPU(s) 706 and other system-level components. The VPU I-cache may supply instruction data to the VPU(s) when requested, may request missing instruction data from system memory, and/or may maintain temporary instruction storage for the VPU. For each VPU task, the CPU(s) 706 may configures the DMA system, optionally prefetch the VPU program into VPU I-cache, and/or kick off each VPU-DMA pair to process a task. The PVA(s) 707 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 707 to access the system memory independently of the CPU(s) 706. The DMA may support any number of features used to provide optimization to the PVA(s) 707 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 707 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 707, and may include one or more vector processing units (VPUs), one or more pixel processing engines (PPEs) – which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 707 may be configured to employ data parallelism. For example, in some embodiments, the plurality of vector processors included in a single PVA(s) 707 may execute the same computer vision algorithm, but on different regions of an image. In other examples, the vector processors included in a particular PVA(s) 707 may simultaneously execute different computer vision algorithms, on the same image, or even execute different algorithms on sequential images or portions of an image. Among other things, any number of PVAs 707 may be included in the hardware acceleration cluster and any number of vector processors may be included in each of the PVAs. In addition, the PVA(s) 707 may include additional error correcting code (ECC) memory, to enhance overall system safety.

The accelerator(s) 714 (e.g., the hardware accelerator cluster) have a wide array of uses for autonomous and semi-autonomous machine control. The PVA(s) 707 may be a programmable vision accelerator that may be used for key processing stages in perception, robotics understanding and reasoning, ADAS, semi-autonomous, and autonomous vehicles, etc. The PVA’s 707 capabilities are a good match for algorithmic domains needing predictable processing, at low power and low latency. In other words, the PVA(s) 707 performs well on semi-dense or dense regular computation, even on small data sets, which need predictable run-times with low latency and low power. Thus, in the context of platforms for autonomous vehicles and robotics, the PVAs 707 are designed to run classic computer vision algorithms, as they are efficient at object detection and operating on integer math.

For example, according to one embodiment of the technology, the PVA 707 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 707 may perform computer stereo vision function on inputs from two monocular cameras.

In some examples, the PVA(s) 707 may be used to perform dense optical flow. According to process raw RADAR data (e.g., using a 4D Fast Fourier Transform) to provide Processed RADAR. In other examples, the PVA(s) 707 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 707, this is not intended to be limiting. In some embodiments, these components may be included in alternative or additional processing components and/or accelerator(s) 714, and/or may be included as discrete components of the SoC(s) 704 and/or other computing system architecture(s).

In some examples, the SoC(s) 704 may include a real-time ray-tracing hardware accelerator (RTA) 751 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 700 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 751 and/or a ray-tracing optimized GPU 706 – such as NVIDIA’s RTX GPU.

The accelerator(s) 714 (e.g., in the hardware acceleration cluster) may include one or more optical flow accelerators (OFAs) 711. For example, the OFA(s) 711 may be used for computing optical flow and stereo disparity between frames of sensor data (e.g., images). Optical flow may be accelerated on the OFA(s) 711 for uses such as object detection and tracking, and/or for stereo depth estimation where used for computing stereo disparity between stereo image frames (e.g., two or more frames captured using two or more image sensors with at least partially overlapping fields of view).

The SoC(s) 704 may include one or more camera serial interfaces (CSIs) 723. For example, the CSI(s) 723 may include a mobile industry processor interface (MIPI) camera serial interface (CSI) for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role. For example, the CSI 723 may include a MIPI CSI-2 connector – e.g., a 16 lane MIPI CSI-2 connector, D-PHY 2.1 (up to 40Gbps), and C-PHY 2.0 (up to 164Gbps) for supporting 16 virtual channels and six or more cameras, an 8 lane MIPI CSI-2 connector, D-PHY 2.1 (up to 20Gbps for supporting 8 virtual channels and 4 or more cameras, and/or a 2x MIPI CSI-2, 22 pin camera connector, depending on the embodiment and implementation.

The accelerator(s) 714 (e.g., the hardware acceleration cluster) may include a computer vision network on-chip (CVNOC) 763 and SRAM, for providing a high-bandwidth, low latency SRAM for the accelerator(s) 714. In some examples, the on-chip memory may include at least 4MB SRAM, consisting of, for example and without limitation, eight field-configurable memory blocks, that may be accessible by the PVA 707, OFA 711, DLA 709, and/or other accelerator(s) 714. Each pair of memory blocks may include an advanced peripheral bus (APB) interface, configuration circuitry, a controller, and a multiplexer. Any type of memory 715 may be used. The PVA 707, OFA 711, DLA 709, and/or other accelerator(s) 714 may access the memory via a backbone that provides the accelerator(s) 714 with high-speed access to memory. The backbone may include a computer vision network on-chip that interconnects the accelerator(s) 714 to the memory (e.g., using the APB).

The CVNOC 763 may include an interface that determines, before transmission of any control signal/address/data, that the accelerator(s) 714 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 704 may include data store(s) 716 and/or memory 715. The data store(s) 716 may be on-chip memory 715 of the SoC(s) 704, which may store neural networks and/or other algorithms to be executed on the CPU(s) 706, the GPU(s) 708, and/or one or more of the accelerator(s) 714. In some examples, the data store(s) 716 may be large enough in capacity to store multiple instances of neural networks for redundancy and safety. The data store(s) 712 may comprise L2 and/or L3 cache(s) 712, for example. The memory(ies) 715 may include SRAM, LPDDR5, and/or other memory types. For example, the memory(ies) 715 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 716 may include reference to the memory associated with the PVA 707, OFA 711, DLA 709, and/or other accelerator(s) 714, as described herein.

The data store(s) 116 may include various storage types, such as eMMC, NVMe, etc. For example, the SoC(s) 704 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 716 and/or other storage may be accessed via, e.g., NVMe, using PCI Express (PCIe), RDMA, TCP, and/or other protocols.

The SoC(s) 704 may include one or more processor(s) 710 (e.g., embedded processors). The processor(s) 710 may include a boot and power management processor (BPMP) 753, that may be a dedicated processor and subsystem to handle boot power and management functions and related security enforcement. The BPMP 753 may be a part of the SoC(s) 704 boot sequence and may provide runtime power management services. The BPMP 753 may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, accelerator(s) 714, and/or other components. If temperatures are determined to exceed a threshold, BPMP 753 may enter a temperature fault routine and put the SoC(s) 704 into a lower power state and/or put the machine 700 into a chauffeur to safe stop mode (e.g., bring the machine 700 to a safe stop).

The processor(s) 710 may further include a set of embedded processors that may serve as an audio processing engine (APE) 755. The APE 755 may be an audio subsystem that enables full hardware support for multi-channel audio over multiple interfaces, and a broad and flexible range of audio I/O interfaces. In some examples, the APE 755 is a dedicated processor core with a digital signal processor with dedicated RAM.

The processor(s) 710 may further include an always on processor engine (AOPE) 757 that may provide necessary hardware features to support low power sensor management and wake use cases. The AOPE 757 may include a processor core, a tightly coupled RAM, supporting peripherals (e.g., timers and interrupt controllers), various I/O controller peripherals, and routing logic.

The processor(s) 710 may further include a safety processor(s) 713 (alternatively referred to as “safety island 713”), which may include a safety cluster engine that includes a dedicated processor or processor subsystem to handle safety management for automotive, robotics, and/or other applications. The safety processor(s) 713 – and/or safety cluster engine – may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 713 may include a discrete processor(s), such that fault of other system components may not impact the performance and availability of the safety processor 713.

The processor(s) 710 may further include a real-time or near real-time sensor engine (SE) 759 that may include a dedicated processor subsystem for handling real-time or near real-time camera, LiDAR, RADAR, and/or other sensor modality management.

The processor(s) 710 may further include one or more image signal processors (ISPs) 727, which may include a high-dynamic range signal processor and/or a hardware engine that is part of one or more sensor processing pipelines.

The processor(s) 710 may include a video image compositor (VIC) 761 that may be a processing block (e.g., implemented on a microprocessor) that implements video post-processing functions needed by a video playback application to produce the final image for the player window. The VIC 761 may perform lens distortion correction on wide-view camera(s) 768B, surround camera(s) 768D, in-cabin monitoring camera sensors, and/or other camera sensors with distorted fields of view.

A VIC 761 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 761 may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a broad range of peripheral interfaces for input/output (I/O) 725, such as to enable communication with peripherals, audio codecs, power management, and/or other devices. The SoC(s) 704 may be used to process data from cameras (e.g., connected over Gigabit Multimedia Serial Link and/or Ethernet), sensors (e.g., LiDAR sensor(s) 764, RADAR sensor(s) 760, etc. that may be connected over Ethernet), data from bus 702 (e.g., speed of machine 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks. In some embodiments, the SoC(s) 704 I/O 725 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 725 elements, components, or features.

The SoC(s) 704 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 704 may include an RJ45 connector with up to 10 GbE, a 1 GbE connector, and/or other networking connector types.

The SoC(s) 104 may include one or more digital signal processors (DSPs) 743. For example, the DSP(s) 743 may include a dedicated or specialized microprocessor chip optimized for digital signal processing – such as in audio signal processing, telecommunications, digital image processing, RADAR, SONAR, LiDAR, and/or other sensor processing, speech recognition, and/or other applications.

The SoC(s) 704 may include one or more video encoders 719 and/or one or more video decoders 721. For example, the video encoder(s) 719 may include a hardware-based (e.g., as part of the GPU(s) 708) video encoder (e.g., supporting H.264, H.265, etc., and being HEVC compliant, such as NVIDIA’s NVENC) that may process image inputs (e.g., as YUV, RGB, etc.) to generate a video bit stream. The video decoder(s) 721 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA’s NVDEC). In some examples, the video decoder(s) 721 may be hardware-based (e.g., as part of the GPU(s) 708).

The SoC(s) 704 may include one or more general compute acceleration clusters (GCAC(s)) 729. For example, the GCAC(s) 729 may include various processor types that may be used to accelerate compute, such as one or more vector microcode processors (VMPs) 733, one or more multi-threaded processing clusters (MPCs) 731, one or more programmable macro arrays (PMA(s)) 735, and/or one or more other processor types. For example, the GCAC(s) 729 may include a PMA 735, two VMPs 733, and 2 MPCs 731.

The SoC(s) 704 may include one or more vector microcode processors (VMPs) 733. The VMP(s) 733, in embodiments, may include a wide vector (very long instruction word (VLIW) and single instruction multiple data (SIMD)) machine with performing various operations, such as short integral type operations common in computer vision and deep learning algorithms.

The SoC(s) 704 may include one or more multi-threaded processing clusters (MPCs) 731. The MPC(s) 731 may include a processing cluster that be, in embodiments, more versatile than a GPU, and with higher efficiency than a CPU. For example, the MPC(s) 731 may include a multi-threaded processor that allows multiple threads to share resources and execute instructions concurrently.

The SoC(s) 704 may include one or more programmable macro arrays (PMA(s)) 735. The PMA(s) 735 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 704 may include one or more display processing units (DPUs) 745 for performing hardware-accelerated image processing. For example, the DPU(s) 745 may retrieve pixel data from memory 715 and send it to a display peripheral through standard interfaces. As such, the DPU(s) 745 may handle display processing and rendering for in-machine and/or on-machine displays.

The SoC(s) 704 may include one or more application processing units (APUs) 739. For example, the APU(s) 739 may include a quad or dual-core processor with 48 KB/32 KB L1 cache with parity and ECC, along with a 1 MB L2 cache with ECC. The APU(s) 739 may support NEON instructions and single and double precision floating point operations.

The SoC(s) 704 may include one or more real-time processing units (RTPUs) 769. The RTPU(s) 769 may include a dual-core processor with 32 KB/32 KB L1 cache, and 256 KB TCM with ECC. The RTPU(s) 769 may support single and double precision floating point operations.

The SoC(s) 704 may include one or more built-in self-test (BIST) components 737. For example, the BIST component(s) 737 may include memory BIST (MBIST) to test memories of the system and/or logic BIST (LBIST) to test logic of the system. The BIST components 737 may include embedded logic for directly testing logic and/or memory of the system.

The SoC(s) 704 may include one or more dynamically reconfigurable processors (DRPs) 771. For example, the DRP(s) 771 may be used for accelerating various computing operations. For example, the DRP(s) 771 may be combined, in embodiments, with a MAC unit for use as an AI accelerator. In embodiments, the DRP(s) 771 may execute applications while dynamically switching the circuit connection configuration of the arithmetic units (e.g., ALUs) on the chip at each operating clock according to the content to be processed. Since only the necessary arithmetic circuits are used, the DRP(s) 771 may consume less power than with CPU processing and can achieve higher speed. Furthermore, compared to CPUs, where frequent external memory accesses due to cache misses and other causes will degrade performance, the DRP(s) 771 can build the necessary data paths in hardware ahead of time, resulting in less performance degradation and less variation in operating speed (jitter) due to memory accesses. The DRP(s) 771 may include a dynamic loading function that switches the circuit connection information each time the algorithm changes, enabling processing with limited hardware resources, even in robotic/automotive applications that require processing of multiple algorithms.

In some embodiments, the accelerator(s) 714 may include an OpenCV accelerator for speeding up processing of OpenCV, an open-source industry standard library for computer vision processing. In some embodiments, the combination of one or more DRP(s) 771 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 704 may include various compute engines (e.g., processors 710, CPUs 706, GPU(s) 708, accelerator(s) 714, etc.), tasks may be distributed between and among the compute engines, in some instances without common cause failures due to the discrete footprint of the compute engines. Further, because the SoC(s) 704 may include a dedicated safety processor(s) 713 (or safety island 713), critical safety or redundant operations may be performed without common cause failures from the main processing components or compute engines of the SoC(s) 714. Due to these features, the SoC(s) 704 and/or the underlying systems of the machine 700 may be capable of satisfying higher levels of safety – such as automotive safety integrity level (ASIL) D from the ISO 26262 standard.

FIG. 7E is a system diagram for communication between a cloud-based server(s) (e.g., in a data center, such as those described herein) and the example autonomous or semi-autonomous vehicle or machine 700 of FIG. 7A, in accordance with some embodiments of the present disclosure. The system 776 may include a server(s) 778, a network(s) 790, and a machine(s) 700. The server(s) 778 may include a plurality of GPUs 784(A)-784(H) (collectively referred to herein as GPUs 784), switches 782(A)-782(H) (such as PCIe 4.0/5.0/etc switches, M.2 slots, thunderbolt, USB4, NVIDIA’s NVLink, NVIDIA’s NVSwitch, GPUDirect RDMA, GPUDirect Storage, etc.), CPUs 780(A)-780(B) (collectively referred to herein as CPUs 780), accelerators, and/or other processor types. The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the machine(s) 700, sensor data indicating information about new or previously unexplored locations, and/or sensor data indicating changes to previously seen/stored locations (e.g., unexpected or changed road conditions, such as recently commenced road-work). The server(s) 778 may transmit, over the network(s) 790 and to the machine(s) 700, neural networks 792, updated neural networks 792, map information 794, etc., including information regarding traffic and road conditions. The updates to the map information 794 may include updates for the HD map 722, SD map, navigation map, etc., such as information regarding construction sites, potholes, detours, flooding, and/or other obstructions. In some examples, the neural networks 792, the updated neural networks 792, the map information 794, and/or the other information may have resulted from new training and/or experiences represented in data received from any number of machine(s) 700 in the environment, and/or based on training performed at a datacenter (e.g., using the server(s) 778 and/or other servers).

The server(s) 778 may be used to train machine learning models (e.g., neural networks) based on training data. The training data may be generated by the machine(s) 700, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 700 (e.g., transmitted to the machine(s) 700 over the network(s) 790, and/or the machine learning models may be used by the server(s) 778 to remotely monitor and/or control the machine(s) 700.

In some examples, the server(s) 778 may receive data from the machine(s) 700 and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the machine 700. For example, the deep-learning infrastructure may receive periodic updates from the machine 700, such as a sequence of images and/or objects that the machine 700 has located in that sequence of images (e.g., via computer vision and/or other machine learning object classification techniques). The deep-learning infrastructure may run its own neural network to identify the objects and compare them with the objects identified by the machine 700 and, if the results do not match and the infrastructure concludes that the AI in the machine 700 is malfunctioning, the server(s) 778 may transmit a signal to the machine 700 instructing a fail-safe computer of the machine 700 to assume control, notify the passengers, and complete a safety maneuver or operation – such as to slow down, hand control back to a driver, come to a stop, and/or pull over/shut down.

For inferencing, the server(s) 778 may include the GPU(s) 784 and one or more programmable inference accelerators (e.g., NVIDIA’s TensorRT). The combination of GPU-powered servers and inference acceleration may make real-time responsiveness possible. In other examples, such as where performance is less critical, servers powered by CPUs, FPGAs, and other processors may be used for inferencing.

### COMPUTING ECOSYSTEM FOR GENERATING, TRAINING, AND DEPLOYING AI

FIG. 8 is a system diagram illustrating a three computer ecosystem 800, including a first computing system 802 for generating or creating artificial intelligence (AI) – such as AI training and validation data, a second computing system 804 for training artificial intelligence, and a third computing system 806 (which may include or correspond to the SoC(s) 704 of FIGS. 7A-7E) deploying the AI at the edge, in accordance with at least some embodiments of the present disclosure. For example, to develop and deploy embodied or physical AI, the three computer ecosystem 800 may be used, including three accelerated computer systems to handle physical AI training, simulation, and runtime (e.g., edge deployment). These systems may generate training data for and train multimodal foundation models (and/or other model types) using scalable, physically based simulations of the machine(s) 700 and their worlds. By doing so, simulation of machine(s) 700 may be performed at scale, allowing for refinement, testing, and optimization of skills (e.g., robot skills) in a virtual world (e.g., using NVIDIA’s OMNIVERSE) that mimics the laws of physics – helping to reduce real-world data acquisition costs and ensuring the machine(s) 700 can perform safely in controlled settings.

The computing system 804 (e.g., NVIDIA’s DGX Platform) may be used to train and fine-tune powerful foundation and generative AI models. Models, such as general purpose foundation models (e.g., NVIDIA’s Project GR00T), may be used to enable robots and other machine(s) 700 to understand natural language and emulate movements by observing human actions. The computing system 804 may include a platform that incorporates software, infrastructure, and expertise in a modern, unified AI development and training solution. The computing system 804 may include individual computing devices 810 (e.g., NVIDIA’s DGX B200, H200, etc.) and/or any number of computing devices 810 in a data center infrastructure 812 (e.g., NVIDIA’s DGX SuperPOD).

For example, the individual computing devices 810 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 810 may include memory (e.g., 4 TB memory, and storage (e.g., OS storage of 2 x 1.9 TB NVMe M.2, and internal storage of 8 x 3.84 TB NVMe U.2). The computing devices 810 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 810 may further include, e.g., dual port quad small form-factor pluggable (QSFFP) data processing units (DPUs) (e.g., 2 dual-port QSFP112 DPUs – such as NVIDIA’s BlueField-3 DPUs), providing up to 400 Gb/s InfiniBand/Ethernet. The computing device(s) 810 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 810 may include SuperNICs (e.g., NVIDIA’s ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 810 may include a smart host channel adapter (HCA) (e.g., NVIDIA’s ConnectX-7) to provide ultra-low latency, 400 Gb/s throughput for in-network computing acceleration engines.

The data center infrastructure 812 may include any number of the computing devices 810, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 810) to thousands, job scheduling and orchestration to ensure hassle-free execution of every developer’s job, AI workflow management and machine learning operations (MLOps) to move more models from prototype to production, and enterprise software to speed developer success.

The computing system 802 (e.g., NVIDIA’s OVX servers) may provide a development and simulation platform for testing and optimizing physical AI with APIs and frameworks for simulation (e.g., NVIDIA’s DriveSIM, ISAAC Sim, ISAAC Gym, ISAAC Labetc.). The computing system 802 allows developers to use simulation frameworks to simulate and validate robot models, and/or to generate massive amounts of physically-based synthetic data to bootstrap model training. The computing system 802 may support learning frameworks that power robot reinforcement learning and imitation learning, to accelerate robot policy training and refinement. For example, the computing system 802 may be used to generate any number of simulations 808 – such as within NVIDIA’s OMNIVERSE. The computing system 802 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA’s RTX), and generative physical AI into existing software tools and simulation workflows for, e.g., industrial and robotics use cases (e.g., NVIDIA’s OMNIVERSE). As such, the computing system 802 may host or support a native OpenUSD software platform enabling enterprises to connect 3D pipelines and develop advanced, real-time 3D applications for industrial digitalization. With powerful ray-tracing-accelerated AI and graphics capabilities, the computing system 802 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 802 may include individual computing devices 814 (e.g., NVIDIA’s OVX L40S Server) and/or any number of computing devices 814 in a data center infrastructure 816 (e.g., NVIDIA’s OVX Systems).

The computing device(s) 814 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4 x 16: 64 GB/s bidirectional interconnect interface, 18,176 CUDA cores, 142 ray tracing (RT) cores, and 568 tensor cores). The computing devices 814 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs – such as an NVIDIA BlueField-3 DPU), providing up to 400 Gb/s InfiniBand/Ethernet. In some embodiments, the NICs used for the computing device(s) 814 may include SuperNICs (e.g., NVIDIA’s ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 814 may include a smart host channel adapter (HCA) (e.g., NVIDIA’s ConnectX-7) to provide ultra-low latency, 400 Gb/s throughput for in-network computing acceleration engines. The computing device(s) 814 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4TB NVMe).

Similar to the data center infrastructure 812, the data center infrastructure 816 may allow for any number of computing device(s) 814 to be combined in cluster configuration according to a reference architecture.

The computing system 806 may be used to deploy trained AI models on a runtime computer – such as the SoC(s) 704 described herein. For example, these computing systems 806 may be designed for compact, on-board computing needs, including an ensemble of models for control policy, vision and language models, etc., deployed on a power-efficient on-board edge computing system 806. Details of components, features, and capabilities of the computing system 806 may be described in more detail herein with respect to FIGS. 7A-7E.

### EXAMPLE GENERATIVE MODELS

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) – such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs – such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures – such as those that rely on self-attention and/or cross-attention (e.g., between contextual data and textual data) mechanisms – may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type – including but not limited to those described herein – may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models – or layers thereof – may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated – e.g., recursively – for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources – such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents – e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc. – as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model – or version, instance, or agent – maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9 is a block diagram of an example generative language model system 900 suitable for use in implementing at least some embodiments of the present disclosure. In the example illustrated in FIG. 9, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a MMLM, a VLA model, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data – such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization (TN), for example, by converting all characters to lowercase, removing accents, and/or or handling special cases like contractions or abbreviations to ensure consistency (e.g., converting ¼ to one quarter). Similarly, the input processor 905 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant – such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve – using a RAG model performing a vector search in an embedding space, for example – the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history – or at least a summary thereof – and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents – which may result in a lack of context, factual correctness, language accuracy, etc. – graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in’s REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features – such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use – or capable of accessing or using – plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated – e.g., recursively – for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources – such as the plug-ins/APIs 995.

In some embodiments, one or more transformer engines (TEs) may be implemented. The transformer engine may use micro-tensor scaling to optimize performance and accuracy – such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices – such as GPUs – to provide better performance with lower memory utilization in both training and inference. When the TE is combined with other technologies, such as high-speed interconnects between nodes (e.g., using switches - such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### EXAMPLE COMPUTING DEVICE

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s), speaker(s), etc.), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs) – which may include one or more direct memory access (DMA) systems, one or more vision or vector processing units (VPUs), one or more pixel processing engines (PPEs) – e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10 – e.g., each device may include similar components, features, and/or functionality of the computing device(s) 1000. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### EXAMPLE CLAUSES

Clause 1. One or more processors comprising processing circuitry to generate at least one frame representing a reverse projection view of an environment surrounding an ego-machine based at least on reverse projecting from a two-dimensional (2D) viewport to one or more frames of a plurality of frames of image data that represent at least partially overlapping views of the environment.

Clause 2. The one or more processors of clause 1, wherein the processing circuitry is further to perform one or more image quality operations to the at least one frame.

Clause 3. The one or more processors of clause 1 or 2, wherein the one or more image quality operations comprise at least one of: temporal noise reduction, super resolution, anti-aliasing, color adjustment, or tone mapping.

Clause 4. The one or more processors of clause 1 or 2, wherein the processing circuitry is further to omit the one or more image quality operations for pixels of the plurality of frames of image data that depict a view outside the reverse projection view.

Clause 5. The one or more processors of clause 1 or 2, wherein the processing circuitry is further to control temporal noise reduction of the one or more image quality operations in one or more regions of the at least one frame based at least on identifying the one or more regions as corresponding to one or more overlapping regions of the image data using the reverse projecting.

Clause 6. The one or more processors of clause 1 or 2, wherein the processing circuitry is further to control a color harmonization process of the one or more image quality operations based at least on identifying, using the reverse projecting, which of the plurality of frames of image data is visible in the reverse projection view.

Clause 7. The one or more processors of clause 1 or 2, wherein the processing circuitry is further to generate a representation of one or more local magnification factors in one or more local regions of the reverse projection view and perform the one or more image quality operations in the one or more local regions of the at least one frame based at least on the one or more local magnification factors.

Clause 8. The one or more processors of clause 7, wherein the processing circuitry is further to identify the one or more local magnification factors in the one or more local regions of the at least one frame based at least on measuring magnification of a projected representation of a dot pattern image.

Clause 9. The one or more processors of clause 7, wherein the processing circuitry is further to identify the one or more local magnification factors in the one or more local regions of the at least one frame based at least on mapping output pixels to corresponding input pixels using the reverse projecting.

Clause 10. The one or more processors of clause 1 or 2, wherein the processing circuitry is further to generate the at least one frame based at least on sampling from the one or more frames of the plurality of frames of image data, wherein the sampling is based at least on one or more local magnification factors in one or more local regions of the at least one frame.

Clause 11. The one or more processors of clause 10, wherein the sampling comprises at least one of subsampling one or more projection indices during the reverse projecting or warping one or more subsampled pixels in the one or more local regions of the at least one frame based at least on the one or more local magnification factors.

Clause 12. The one or more processors of clause 10, wherein the sampling comprises performing at least one of super resolution processing or anti-aliasing in the one or more local regions of the at least one frame based at least on the one or more local magnification factors.

Clause 13. The one or more processors of clause 1 or 2, wherein the processing circuitry is further to control at least one of temporal noise reduction, color adjustment, or tone mapping of the one or more image quality operations in one or more local regions of the at least one frame based at least on one or more local magnification factors corresponding to the one or more local regions.

Clause 14. The one or more processors of clause 1 or 2, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Clause 15. A system comprising one or more processors to generate at least one frame representing a reverse projection view of an environment of an ego-machine based at least on reverse projecting from a two-dimensional (2D) viewport to one or more frames of a plurality of frames of image data representing at least partially overlapping views of the environment.

Clause 16. The system of clause 15, wherein the one or more processors are further to perform one or more image quality operations to the at least one frame.

Clause 17. The system of clause 15 or 16, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Clause 18. A system comprising one or more processors to control, within a simulation rendered using one or more light transport simulation algorithms, an infotainment system of a simulated vehicle in a simulated environment to present a visualization of the simulated environment, the visualization generated based at least on: reverse projecting from a two-dimensional (2D) viewport to at least one frame of a plurality of frames of simulated image data representing at least partially overlapping views of the simulated environment, and performing one or more image quality operations on pixels corresponding to the at least one frame.

Clause 19. The system of clause 18, wherein the simulation is generated, at least in part, using one or more content creation applications of a three-dimensional (3D) content collaboration platform for 3D assets.

Clause 20. The system of clause 19, wherein the simulated environment is represented in at least one content creation application of the one or more content creation applications using an OpenUSD format.

Clause 21. The system of clause 18, wherein one or more processors are further to omit the one or more image quality operations for pixels of the at least one frame that are outside the 2D viewport.

Clause 22. The system of clause 18, wherein at least one language model of the one or more language models is implemented in at least one processing node of a plurality of processing nodes of a data center and accessible to one or more remote clients via at least one of an application programming interface (API), or an application plug-in.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate at least one frame representing a reverse projection view of an environment surrounding an ego-machine based at least on reverse projecting from a two-dimensional (2D) viewport to one or more frames of a plurality of frames of image data that represent at least partially overlapping views of the environment; and
perform one or more image quality operations to the at least one frame.

2. The one or more processors of claim 1, wherein the one or more image quality operations comprise at least one of: temporal noise reduction, super resolution, anti-aliasing, color adjustment, or tone mapping.

3. The one or more processors of claim 1, wherein the processing circuitry is further to omit the one or more image quality operations for pixels of the plurality of frames of image data that depict a view outside the reverse projection view.

4. The one or more processors of claim 1, wherein the processing circuitry is further to control temporal noise reduction of the one or more image quality operations in one or more regions of the at least one frame based at least on identifying the one or more regions as corresponding to one or more overlapping regions of the image data using the reverse projecting.

5. The one or more processors of claim 1, wherein the processing circuitry is further to control a color harmonization process of the one or more image quality operations based at least on identifying, using the reverse projecting, which of the plurality of frames of image data is visible in the reverse projection view.

6. The one or more processors of claim 1, wherein the processing circuitry is further to generate a representation of one or more local magnification factors in one or more local regions of the reverse projection view and perform the one or more image quality operations in
the one or more local regions of the at least one frame based at least on the one or more local magnification factors.

7. The one or more processors of claim 6, wherein the processing circuitry is further to identify the one or more local magnification factors in the one or more local regions of the at least one frame based at least on measuring magnification of a projected representation of a dot pattern image.

8. The one or more processors of claim 6, wherein the processing circuitry is further to identify the one or more local magnification factors in the one or more local regions of the at least one frame based at least on mapping output pixels to corresponding input pixels using the reverse projecting.

9. The one or more processors of claim 1, wherein the processing circuitry is further to generate the at least one frame based at least on sampling from the one or more frames of the plurality of frames of image data, wherein the sampling is based at least on one or more local magnification factors in one or more local regions of the at least one frame.

10. The one or more processors of claim 9, wherein the sampling comprises at least one of subsampling one or more projection indices during the reverse projecting or warping one or more subsampled pixels in the one or more local regions of the at least one frame based at least on the one or more local magnification factors.

11. The one or more processors of claim 9, wherein the sampling comprises performing at least one of super resolution processing or anti-aliasing in the one or more local regions of the at least one frame based at least on the one or more local magnification factors.

12. The one or more processors of claim 1, wherein the processing circuitry is further to control at least one of temporal noise reduction, color adjustment, or tone mapping of the one or more image quality operations in one or more local regions of the at least one frame based at least on one or more local magnification factors corresponding to the one or more local regions.

13. The one or more processors of claim 1, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative Al operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational Al operations;
a system for generating synthetic data;
a system for presenting at least one of virtual reality content, augmented reality content, or mixed reality content;
a system incorporating one or more virtual machines (VMs);
a system implemented at least partially in a data center; or a system implemented at least partially using cloud computing resources.

14. A system comprising one or more processors to:
generate at least one frame representing a reverse projection view of an environment of an ego-machine based at least on reverse projecting from a two-dimensional (2D) viewport to
one or more frames of a plurality of frames of image data representing at least partially overlapping views of the environment; andperform one or more image quality operations to the at least one frame.

15. The system of claim 14, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative Al operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational Al operations;
a system for generating synthetic data;
a system for presenting at least one of virtual reality content, augmented reality content, or mixed reality content;
a system incorporating one or more virtual machines (VMs);
a system implemented at least partially in a data center; or a system implemented at least partially using cloud computing resources.

16. A system comprising:
one or more processors to control, within a simulation rendered using one or more light transport simulation algorithms, an infotainment system of a simulated vehicle in a simulated environment to present a visualization of the simulated environment, the visualization generated based at least on: reverse projecting from a two-dimensional (2D) viewport to at least one frame of a plurality of frames of simulated image data representing at least partially overlapping views of the simulated environment, and performing one or more image quality operations on pixels corresponding to the at least one frame.

17. The system of claim 16, wherein the simulation is generated, at least in part, using one or more content creation applications of a three-dimensional (3D) content collaboration platform for 3D assets.

18. The system of claim 17, wherein the simulated environment is represented in at least one content creation application of the one or more content creation applications using an OpenUSD format.

19. The system of claim 16, wherein one or more processors are further to omit the one or more image quality operations for pixels of the at least one frame that are outside the 2D viewport.

20. The system of claim 16, wherein at least one language model of the one or more language models is implemented in at least one processing node of a plurality of processing nodes of a data center and accessible to one or more remote clients via at least one of an application programming interface (API), or an application plug-in.
